(19) United States
(12) Patent Application Publication
(10) Pub. No.: US 2025/0015298 A1
(43) Pub. Date: Jan. 9, 2025

(54) SECONDARY BATTERY AND ELECTRONIC DEVICE

(71) Applicant: SEMICONDUCTOR ENERGY LABORATORY CO., LTD., Atsugi-shi, Kanagawa-ken (JP)

(72) Inventors: Shunpei YAMAZAKI, Setagaya, Tokyo (JP); Tetsuya KAKEHATA, Isehara, Kanagawa (JP); Tetsuji ISHITANI, Atsugi, Kanagawa (JP); Kazutaka KURIKI, Ebina, Kanagawa (JP); Masayuki KIMURA, Atsugi, Kanagawa (JP); Yasuhiro JINBO, Isehara, Kanagawa (JP)

(21) Appl. No.: 18/712,312

(22) PCT Filed: Nov. 17, 2022
(86) PCT No.: PCT/IB2022/061049

§ 371 Date: May 22, 2024

(30) Foreign Application Priority Data
Nov. 26, 2021 (JP) 2021-192172

(51) Int. Cl. H01M 4/66; H01M 4/02; H01M 4/62; H01M 10/0525

(52) U.S. Cl. CPC H01M 4/66; H01M 4/622; H01M 10/0525; H01M 2004/028; H01M 2004/029

(57) ABSTRACT

A secondary battery that can inhibit degradation of an electrode is provided. A flexible secondary battery is provided. A flexible secondary battery includes a positive electrode, a negative electrode, and an exterior body surrounding the positive electrode and the negative electrode. The positive electrode includes a positive electrode current collector and a positive electrode active material layer provided over the positive electrode current collector. The negative electrode includes a negative electrode current collector and a negative electrode active material layer provided over the negative electrode current collector. One or both of the positive electrode current collector and the negative electrode current collector have rubber elasticity.

### TECHNICAL FIELD

One embodiment of the present invention relates to an object, a method, or a manufacturing method. Alternatively, the present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that an electronic device in this specification refers to all devices including power storage devices, and electro-optical devices including power storage devices, information terminal devices including power storage devices, and the like are all electronic devices.

Note that in this specification, a power storage device refers to all elements and devices each having a function of storing power. For example, a power storage device (also referred to as a secondary battery) such as a lithium-ion secondary battery, a lithium-ion capacitor, and an electric double layer capacitor are included.

### BACKGROUND ART

In recent years, wearable devices have been under active development. Since wearable devices are worn on one's body, they preferably have curved shapes along a curved surface of the body or they are preferably curved according to the movement of the body. Thus, not only displays but also secondary batteries mounted in wearable devices preferably have flexibility. Secondary batteries mounted in devices other than the wearable devices also preferably have flexibility because the space inside the devices can be used more efficiently when the secondary batteries can be changed in shape.

As the secondary batteries, a variety of power storage devices such as lithium-ion secondary batteries, lithium-ion capacitors, and air batteries have been actively developed. In particular, demands for lithium-ion secondary batteries with high output and high energy density have rapidly grown with the industry development, for portable information terminals such as mobile phones, smartphones, and laptop computers, portable music players, digital cameras, medical equipment, next-generation clean energy vehicles such as hybrid electric vehicles (HVs), electric vehicles (EVs), and plug-in hybrid electric vehicles (PHVs), and the like, and the lithium-ion secondary batteries are essential as rechargeable energy supply sources for today's information society.

For example, Patent Document 1 discloses as a flexible secondary battery an electrochemical device (e.g., a secondary battery or a capacitor) which is covered with a metal laminate and which can be easily curved or can easily maintain a curved state.

### REFERENCES

### Patent Document

[Patent Document 1] Japanese Published Patent Application No. 2004-241250
[Patent Document 2] Japanese Published Patent Application No. 2016-27542

### SUMMARY OF THE INVENTION

### Problems to be Solved by the Invention

A secondary battery with a curved shape includes an exterior body formed using a flexible material such as a laminated film, and is provided with a positive electrode lead and a negative electrode lead to take a positive electrode and a negative electrode out of the exterior body. Here, the positive electrode lead and the negative electrode lead are sandwiched by an exterior body and fixed. The positive electrode lead is connected to a positive electrode tab (part of a positive electrode current collector) provided in the positive electrode, and the negative electrode lead is connected to a negative electrode tab (part of a negative electrode current collector) provided in the negative electrode. The positive electrode tab and the negative electrode tab have shapes in which part of the current collector in each electrode is elongated. Thus, the positive electrode tab and the negative electrode tab are likely to cause degradation such as a crack or a breakage compared with main portions of the electrodes.

In particular, in the case where the positive electrode lead and the negative electrode lead are each connected to a side of an end portion in a curved direction of the secondary battery as disclosed in Patent Document 1, stress due to change in shape of the secondary battery tends to concentrate on a positive electrode lead connection portion and a negative electrode lead connection portion. Thus, the positive electrode lead connection portion and the negative electrode lead connection portion might be cracked or broken when an electronic device including the secondary battery is changed in shape (e.g., bent and unbent) repeatedly, for example.

Against such problems, for example, a structure of a secondary battery with an electrode where part of a current collector and part of an active material are removed has been studied as disclosed in Patent Document 2. However, there is room for improvement in the internal structure of the secondary battery, the method for manufacturing the secondary battery, and the like.

In view of the above problems, an object of one embodiment of the present invention is to provide a secondary battery with a structure that can inhibit degradation of a positive electrode and/or a negative electrode, in particular, a positive electrode current collector and/or a negative electrode current collector.

Another object of one embodiment of the present invention is to provide a method for manufacturing a secondary battery with a structure that can inhibit degradation of a positive electrode and/or a negative electrode, in particular, a positive electrode current collector and/or a negative electrode current collector.

Another object of one embodiment of the present invention is to provide a secondary battery with a novel structure. Specifically, an object is to provide a flexible secondary battery with a novel structure. Another object of one embodiment of the present invention is to provide a novel power storage device, an electronic device including a novel secondary battery, or the like.

Note that the description of these objects does not preclude the existence of other objects. One embodiment of the present invention does not necessarily need to achieve all of these objects. Other objects will be apparent from the description of the specification, the drawings, the claims, and the like, and other objects can be derived from the description of the specification, the drawings, the claims, and the like.

### Means for Solving the Problems

In the case of manufacturing and using a flexible secondary battery or manufacturing a curved secondary battery, when a plurality of electrodes are curved, the plurality of electrodes are curved with different curvatures. An electrode far from a curvature center is more curved than an electrode close to the curvature center and is therefore brought into a state where an end portion thereof is shifted in position or is extended. The end portion of the electrode includes an electrode tab connected to a lead.

In the case of manufacturing a secondary battery, a stack is manufactured by stacking a plurality of combinations of positive and negative electrodes in a region surrounded by an exterior body.

With an increase in the number of stacked layers, a capacity and a thickness thereof are increased. Therefore, the electrode far from the curvature center is more curved than the electrode close to the curvature center, so that the end portion thereof is significantly shifted in position or is extended.

Thus, in one embodiment of the present invention, a positive electrode and/or a negative electrode, in particular, a positive electrode current collector and/or a negative electrode current collector have/has a stretchable structure. Specifically, a conductive film exhibiting rubber elasticity is used as the positive electrode current collector and/or the negative electrode current collector. It is preferable that a positive electrode active material layer included in the positive electrode and/or a negative electrode active material layer included in the negative electrode contain a material exhibiting rubber elasticity as a binder.

One embodiment of the present invention is a secondary battery including a positive electrode and a negative electrode, in which the positive electrode includes a positive electrode current collector, the negative electrode includes a negative electrode current collector, and one of the positive electrode current collector and the negative electrode current collector contains a first rubber material.

Another embodiment of the present invention is a secondary battery including a positive electrode and a negative electrode, in which the positive electrode includes a positive electrode current collector, the negative electrode includes a negative electrode current collector, and one of the positive electrode current collector and the negative electrode current collector has rubber elasticity.

Another embodiment of the present invention is a secondary battery including a positive electrode and a negative electrode, in which the positive electrode includes a positive electrode current collector, the negative electrode includes a negative electrode current collector, the positive electrode current collector contains a first rubber material, and the negative electrode current collector contains a second rubber material.

Another embodiment of the present invention is a secondary battery including a positive electrode and a negative electrode, in which the positive electrode includes a positive electrode current collector, the negative electrode includes a negative electrode current collector, and each of the positive electrode current collector and the negative electrode current collector has rubber elasticity.

In any one of the above-described secondary batteries, it is preferable that the secondary battery have flexibility and have at least a first shape and a second shape and that a thickness of the positive electrode current collector in the first shape be smaller than a thickness of the positive electrode current collector in the second shape.

In any one of the above-described secondary batteries, it is preferable that the secondary battery have flexibility and have at least a first shape and a second shape and that a thickness of the negative electrode current collector in the first shape be smaller than a thickness of the negative electrode current collector in the second shape.

In any one of the above-described secondary batteries, it is preferable that the positive electrode include a positive electrode active material layer on at least one surface of the positive electrode current collector and that the positive electrode active material layer contain a positive electrode active material and a second rubber material.

In any one of the above-described secondary batteries, it is preferable that the positive electrode include a positive electrode active material layer on at least one surface of the positive electrode current collector and that the positive electrode active material layer contain a positive electrode active material and a third rubber material.

In any one of the above-described secondary batteries, it is preferable that the negative electrode include a negative electrode active material layer on at least one surface of the negative electrode current collector and that the negative electrode active material layer contain a negative electrode active material and a third rubber material.

In any one of the above-described secondary batteries, it is preferable that the positive electrode include a positive electrode active material layer on at least one surface of the positive electrode current collector and that the positive electrode active material layer contain a positive electrode active material and a rubber material.

In any one of the above-described secondary batteries, it is preferable that the negative electrode include a negative electrode active material layer on at least one surface of the negative electrode current collector and that the negative electrode active material layer contain a negative electrode active material and a rubber material.

In any one of the above-described secondary batteries, it is preferable that the second rubber material and the third rubber material be each styrene-butadiene rubber.

In any one of the above-described secondary batteries, it is preferable that the secondary battery include an exterior body surrounding the positive electrode and the negative electrode and that the exterior body include a projection and a depression.

One embodiment of the present invention is an electronic device including any one of the above-described secondary batteries.

### Effect of the Invention

One embodiment of the present invention can provide a secondary battery with a structure that can inhibit degradation of a positive electrode and/or a negative electrode, in particular, a positive electrode current collector and/or a negative electrode current collector.

Another embodiment of the present invention can provide a method for manufacturing a secondary battery with a structure that can inhibit degradation of a positive electrode and/or a negative electrode, in particular, a positive electrode current collector and/or a negative electrode current collector.

Another embodiment of the present invention can provide a secondary battery with a novel structure. More specifically, a flexible secondary battery with a novel structure can be provided. Another embodiment of the present invention can provide a novel power storage device, an electronic device including a novel secondary battery, or the like.

Note that the description of these effects does not preclude the existence of other effects. One embodiment of the present invention does not necessarily need to have all of these effects. Other effects will be apparent from the description of the specification, the drawings, the claims, and the like, and other effects can be derived from the description of the specification, the drawings, the claims, and the like.

### BRIEF DESCRIPTION OF THE DRAWINGS

FIG. 1A and FIG. 1B are diagrams illustrating an example of a cross section of electrodes, and

FIG. 1C and FIG. 1D are schematic cross-sectional views illustrating a change in shape of a current collector.

FIG. 2A and FIG. 2B are cross-sectional views illustrating a structure example of a secondary battery.

FIG. 3A and FIG. 3B are cross-sectional views illustrating a structure example of a secondary battery.

FIG. 4A to FIG. 4E are diagrams illustrating a structure example of a secondary battery.

FIG. 5A to FIG. 5C are diagrams illustrating structure examples of secondary batteries.

FIG. 6A to FIG. 6C are diagrams illustrating structure examples of secondary batteries.

FIG. 7A to FIG. 7C are diagrams illustrating structure examples of secondary batteries.

FIG. 8 is a diagram illustrating a method for processing a film.

FIG. 9A to FIG. 9E are diagrams each illustrating a method for processing a film.

FIG. 10A and FIG. 10B are diagrams illustrating a method for processing a film.

FIG. 11A and FIG. 11B are diagrams illustrating an electronic device of one embodiment of the present invention.

FIG. 12A and FIG. 12B are diagrams illustrating an electronic device of one embodiment of the present invention.

FIG. 13A to FIG. 13D are diagrams each illustrating an electronic device of one embodiment of the present invention.

FIG. 14A to FIG. 14D are diagrams each illustrating an electronic device of one embodiment of the present invention.

FIG. 15A to FIG. 15C are diagrams illustrating an electronic device of one embodiment of the present invention.

FIG. 16A to FIG. 16C are diagrams illustrating an electronic device of one embodiment of the present invention.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

The term “electrically connected” includes the case where components are connected through an “object having any electric function”. There is no particular limitation on the “object having any electric function” as long as electric signals can be transmitted and received between the components connected through the object.

The position, size, range, or the like of each component illustrated in drawings and the like is not accurately represented in some cases for easy understanding. Therefore, the disclosed invention is not necessarily limited to the position, size, range, and the like disclosed in the drawings and the like.

Ordinal numbers such as “first”, “second”, and “third” are used to avoid confusion among components.

In this specification, “parallel” indicates a state where two straight lines are placed at an angle greater than or equal to −10° and less than or equal to 10°. Thus, the case where the angle is greater than or equal to −5° and less than or equal to 5° is also included. In addition, “approximately parallel” or “substantially parallel” indicates a state where two straight lines are placed at an angle greater than or equal to −30° and less than or equal to 30°.

In this specification, “perpendicular” indicates a state where two straight lines are placed at an angle greater than or equal to 800 and less than or equal to 100°. Thus, the case where the angle is greater than or equal to 850 and less than or equal to 950 is also included. Furthermore, “approximately perpendicular” or “substantially perpendicular” indicates a state where two straight lines are placed at an angle greater than or equal to 600 and less than or equal to 120°.

The particle diameter of a particle can be measured by, for example, laser diffraction particle size distribution measurement and can be represented as D50. D50 is a particle diameter when the accumulated amount of particles accounts for 50% of an accumulated particle amount curve which is the result of the particle size distribution measurement, i.e., a median diameter. The measurement of the particle diameter of a particle is not limited to laser diffraction particle size distribution measurement; in the case where the particle diameter of a particle is less than or equal to the lower measurement limit of laser diffraction particle size distribution measurement, the cross-sectional diameter of the particle may be measured by analysis with a SEM (scanning electron microscope), a TEM (transmission electron microscope), or the like. As a method for measuring the particle diameter of a particle whose cross-sectional shape is not a circle, for example, the cross-sectional area of the particle is calculated by image processing or the like, whereby the particle diameter can be estimated assuming that the particle has a circular cross section with the equivalent area.

Note that in the drawings illustrating the present invention, some structures (e.g., the ratio between the size and the thickness of an electrode) are exaggerated for easy understanding in some cases. Furthermore, some components are not illustrated in some cases to avoid complexity of the drawings.

### Embodiment 1

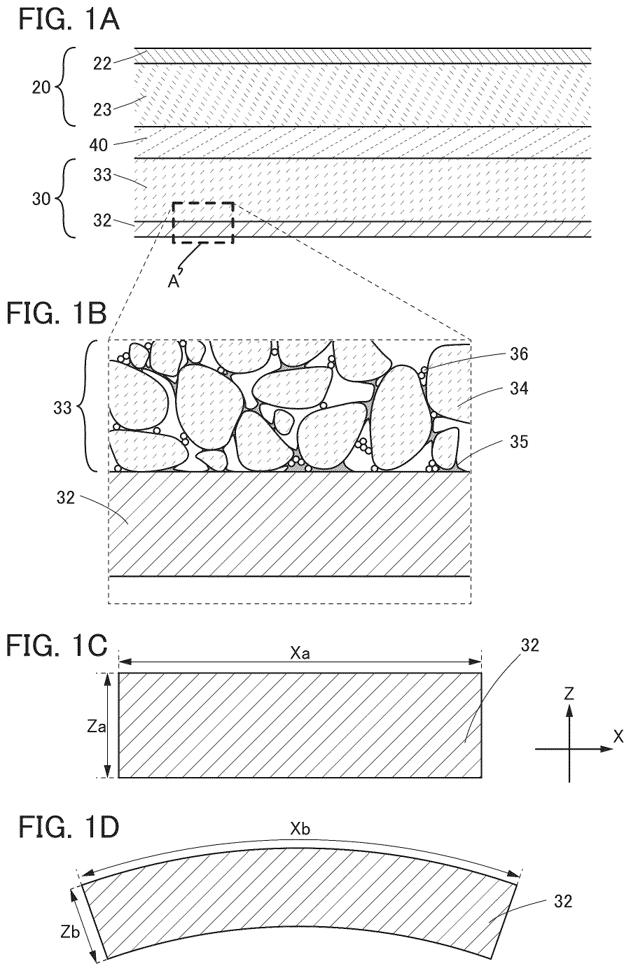

In this embodiment, structure examples of a flexible secondary battery (sometimes referred to as a flexible battery, a curved battery, or a bendable battery) of one embodiment of the present invention will be described with reference to FIG. 1 to FIG. 7.

### [Secondary Battery]

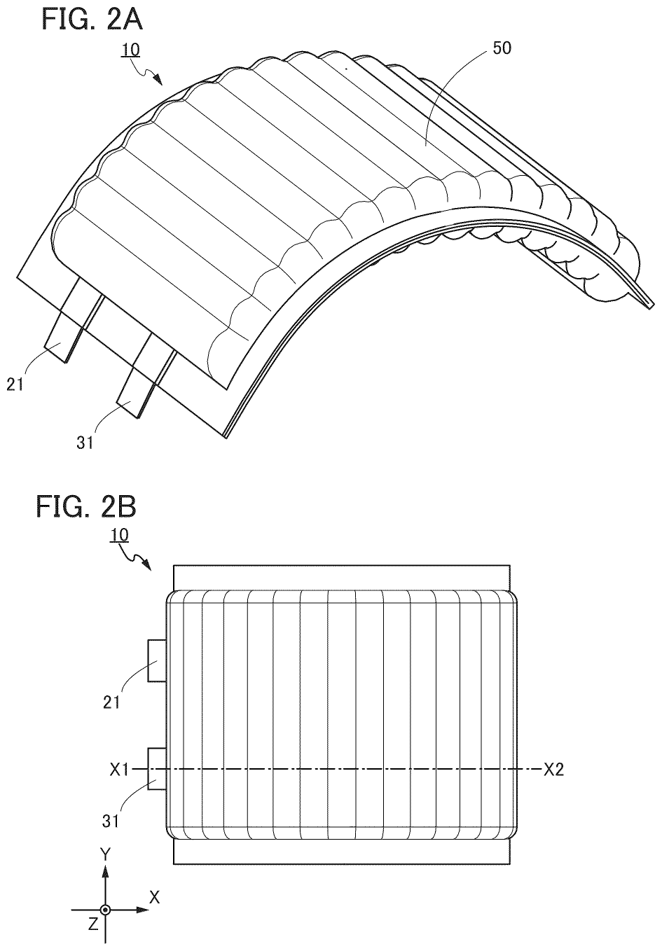

FIG. 1A to FIG. 1D are schematic cross-sectional views illustrating a positive electrode 20, a negative electrode 30, and a separator 40 included in a secondary battery 10 of one embodiment of the present invention that is illustrated in FIG. 2. FIG. 2A is a perspective view of the secondary battery 10.

In the schematic cross-sectional view illustrated in FIG. 1A, the positive electrode 20 includes a positive electrode current collector 22 and a positive electrode active material layer 23. The negative electrode 30 includes a negative electrode current collector 32 and a negative electrode active material layer 33. The positive electrode 20 and the negative electrode 30 overlap with each other such that the positive electrode active material layer 23 and the negative electrode active material layer 33 face each other with the separator 40 therebetween.

Electrodes of one embodiment of the present invention are described with reference to FIG. 1B to FIG. 1D. FIG. 1B is an example of an enlarged view of a region surrounded by a dashed line in FIG. 1A.

In the schematic cross-sectional view illustrated in FIG. 1B in which part of the negative electrode 30 is enlarged, the negative electrode active material layer 33 provided over the negative electrode current collector 32 contains a negative electrode active material 34 and a binder 35. Note that the negative electrode active material layer 33 may contain a conductive material 36 in addition to the negative electrode active material 34 and the binder 35, but does not necessarily contain the conductive material 36 when the conductivity of the negative electrode active material 34 is sufficiently high.

As the binder 35 contained in the negative electrode 30, a material exhibiting rubber elasticity (also referred to as a rubber material) is preferably used. Materials that can be used as the binder 35 will be described in detail later.

Note that rubber elasticity refers to unique elasticity exhibited by a substance such as rubber. Rubber elasticity has features such as high elastic limit (stress at a limit point of no return to the original shape after removal of external force) and low Young's modulus (greater than or equal to 0.1 MPa and less than or equal to 10 MPa). As the material exhibiting rubber elasticity, a material having a net-like molecular structure in which chain-like molecules are cross-linked (also referred to as “vulcanized”) is known.

FIG. 1C and FIG. 1D are diagrams illustrating the negative electrode current collector 32 included in the negative electrode 30. As the negative electrode current collector 32, a conductive film exhibiting rubber elasticity is preferably used. The conductive film exhibiting rubber elasticity that can be used as the negative electrode current collector 32 will be described in detail later.

FIG. 1C is a schematic diagram illustrating the negative electrode current collector 32 in the case where the secondary battery 10 is not curved, and FIG. 1D is a schematic diagram illustrating the negative electrode current collector 32 in the case where the secondary battery 10 is curved. Note that a change in shape is exaggerated in FIG. 1C and FIG. 1D for easy understanding. In the case where a conductive film exhibiting rubber elasticity is used as the negative electrode current collector 32, the negative electrode current collector 32 has rubber elasticity (also referred to as stretchability); thus, in the case where the secondary battery 10 is curved, the negative electrode 30 can be extended in the curving direction (the X direction in the drawing). That is, the value of a length Xb of the negative electrode current collector 32 in the X direction in the case where the secondary battery 10 is curved is larger than the value of a length Xa of the negative electrode current collector 32 in the X direction in the case where the secondary battery 10 is not curved. In addition, the value of a length Zb of the negative electrode current collector 32 in the Z direction (also referred to as a thickness Zb of the negative electrode current collector 32) in the case where the secondary battery 10 is curved is smaller than the value of a length Za of the negative electrode current collector 32 in the Z direction (also referred to as a thickness Za of the negative electrode current collector 32) in the case where the secondary battery 10 is not curved.

That is, the negative electrode 30 that includes the negative electrode current collector 32 having rubber elasticity and the negative electrode active material layer 33 containing the binder 35 having rubber elasticity as described above can be regarded as a negative electrode having rubber elasticity.

Note that the electrodes included in the secondary battery 10 of one embodiment of the present invention are described using the negative electrode 30 as an example in FIG. 1B and FIG. 1C; the same applies to the positive electrode 20. In the description of FIG. 1B and FIG. 1C, the negative electrode 30 can be replaced with the positive electrode 20, the negative electrode current collector 32 with the positive electrode current collector 22, and the negative electrode active material layer 33 with the positive electrode active material layer 23. That is, the positive electrode 20 that includes the positive electrode current collector 22 having rubber elasticity and the positive electrode active material layer 23 containing a binder having rubber elasticity can be regarded as a positive electrode having rubber elasticity.

FIG. 2B is atop view of the secondary battery 10 illustrated in FIG. 2A. The secondary battery 10 illustrated in FIG. 2A and FIG. 2B includes an exterior body 50, and a positive electrode lead 21 and a negative electrode lead 31 which extend from the inside to the outside of a space surrounded by the exterior body 50.

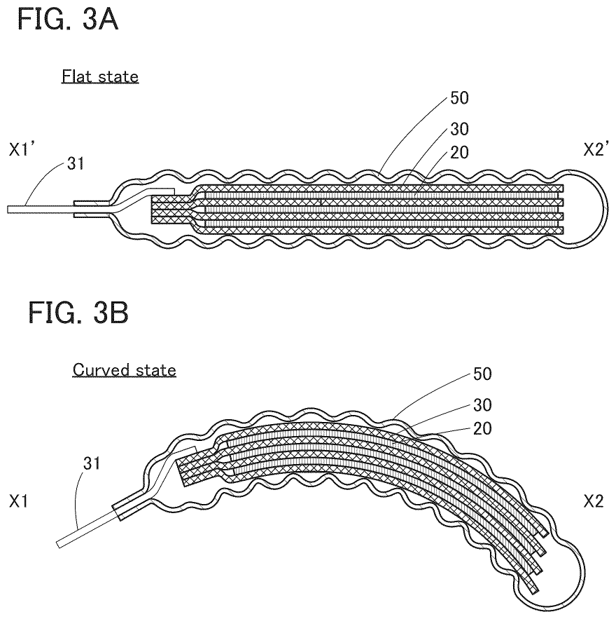

FIG. 3A and FIG. 3B are schematic cross-sectional views taken along dashed-dotted line X1-X2 in FIG. 2B. FIG. 3A illustrates a state where the secondary battery 10 is not curved (a flat state) and FIG. 3B illustrates a state where the secondary battery 10 is curved (a curved state). Note that in FIG. 3A and FIG. 3B, a separator is not illustrated to avoid complexity of the drawings.

When the secondary battery 10 is curved, the end portions of a plurality of positive electrodes 20 and a plurality of negative electrodes 30 are shifted in position at a side of the end portion of the secondary battery 10 in the curving direction. This shift causes a shift in a region where the positive electrode active material layer 23 and the negative electrode active material layer 33 face each other, and thus might lead to an uneven battery reaction; however, the positive electrode 20 and/or the negative electrode 30 included in the secondary battery 10 of one embodiment of the present invention have/has rubber elasticity and thus can reduce the above-described shift caused when the secondary battery 10 is curved. Furthermore, stress applied to inner members of the secondary battery 10 (the positive electrode 20, the negative electrode 30, and the separator 40) when the secondary battery 10 is curved can be reduced. That is, degradation of the positive electrode 20 and/or the negative electrode 30, in particular, the positive electrode current collector 22 and/or the negative electrode current collector 32 can be inhibited.

When the secondary battery 10 is curved, the positive electrode 20 and/or the negative electrode 30 having rubber elasticity may be extended in the curving direction. In addition, when the secondary battery 10 is curved, the positive electrode current collector 22 and/or the negative electrode current collector 32 having rubber elasticity may be extended in the curving direction.

For example, in the secondary battery 10 in the curved shape illustrated in FIG. 3B, the thickness of the positive electrode current collector 22 and/or the negative electrode current collector 32 may be decreased as described with reference to FIG. 1C and FIG. 1D. In other words, the thickness of the positive electrode current collector 22 and/or the negative electrode current collector 32 in the case where the secondary battery 10 has a curved shape can be regarded as being smaller than the thickness of the positive electrode current collector 22 and/or the negative electrode current collector 32 in the case where the secondary battery 10 has a flat shape.

As illustrated in FIG. 3A, FIG. 3B, and the like, the secondary battery 10 can be repeatedly changed into at least two shapes such as a non-curved shape and a curved shape. Possible shapes of the secondary battery 10 of one embodiment of the present invention are not limited to the shapes illustrated in FIG. 3A, FIG. 3B, and the like. The secondary battery 10 may have two possible shapes of a curved shape with a first curvature radius and a curved shape with a second curvature radius different from the first curvature radius, or the secondary battery 10 may be changed into a plurality of different shapes such as a curved shape with a third curvature radius different from each of the first curvature radius and the second curvature radius.

Although the shape in which the whole secondary battery 10 is uniformly curved is illustrated as the shape of the secondary battery 10 in FIG. 3A, FIG. 3B, and the like, the secondary battery 10 may include a first region that can be curved with a first curvature radius and a second region that can be curved with a second curvature radius different from the first curvature radius. Alternatively, the secondary battery 10 may include a region that can be curved with two or more different curvature radii.

The secondary battery 10 may include a first region that can be curved, a second region that is flat, and a third region that is flat so as to have a bi-foldable shape. Alternatively, the secondary battery 10 may include a first region that can be curved, a second region that can be curved, a third region that is flat, a fourth region that is flat, and a fifth region that is flat so as to have a ti-foldable shape.

### [Negative Electrode]

A negative electrode includes a negative electrode active material layer and a negative electrode current collector. The negative electrode active material layer contains a negative electrode active material and may further contain a conductive material and a binder.

The negative electrode active material layer can be formed by applying slurry onto the negative electrode current collector and drying the slurry. Note that pressing may be performed after drying. The negative electrode is obtained by forming the negative electrode active material layer over the negative electrode current collector.

Slurry refers to a material solution that is used to form an active material layer over a current collector and includes an active material, a binder, and a solvent, preferably also a conductive material mixed therewith. Slurry may also be referred to as slurry for an electrode or active material slurry; in some cases, slurry for forming a negative electrode active material layer is referred to as slurry for a negative electrode.

### <Rubber-Like Current Collector>

As a current collector, a conductive film exhibiting rubber elasticity can be used. The conductive film exhibiting rubber elasticity that is used as a current collector is referred to as a rubber-like current collector in some cases. For example, a rubber-like current collector containing any one or more rubber materials selected from styrene-butadiene rubber, styrene-isoprene-styrene rubber, acrylonitrile-butadiene rubber, butadiene rubber, ethylene-propylene-diene copolymer, butyl rubber, ethylene-propylene rubber, fluororubber, silicone rubber, and urethane rubber and a particulate or fibrous conductive material (also referred to as a conductive filler) can be used as the rubber-like current collector.

As the physical properties of the rubber-like current collector, tensile strength, elongation at break, and volume resistivity, for example, are preferably within the following ranges. The tensile strength is preferably greater than or equal to 0.1 MPa and less than or equal to 30 MPa, further preferably greater than or equal to 1 MPa and less than or equal to 20 MPa, still further preferably greater than or equal to 1 MPa and less than or equal to 10 MPa. The elongation at break is preferably greater than 100% and less than or equal to 300%, further preferably greater than or equal to 130% and less than or equal to 200% (assuming the length without application of external force is 100%). The volume resistivity is preferably greater than or equal to 0.1 Ω·m and less than or equal to 30 Ω·m, further preferably greater than or equal to 0.1 Ω·m and less than or equal to 20 Ω·m, still further preferably greater than or equal to 0.1 Ω·m and less than or equal to 10 Ω·m, yet further preferably greater than or equal to 0.1 Ω·m and less than or equal to 5 Ω·m.

As the conductive material contained in the rubber-like current collector, a conductive carbon material and one or more of metal materials such as aluminum, titanium, stainless steel, gold, platinum, zinc, iron, and copper can be used. For example, one kind or two or more kinds of carbon black such as acetylene black or furnace black, graphite such as artificial graphite or natural graphite, carbon fiber such as carbon nanofiber or carbon nanotube, graphene, and a graphene compound can be used as the conductive carbon material.

As the carbon fiber, for example, carbon fiber such as mesophase pitch-based carbon fiber or isotropic pitch-based carbon fiber can be used. Carbon nanofiber, carbon nanotube, or the like can also be used as the carbon fiber. Carbon nanotube can be formed by, for example, a vapor deposition method.

Note that in the case where the rubber-like current collector is used as a positive electrode current collector, an antioxidant such as a hindered phenol-based material may be further contained.

Note that in the case where the rubber-like current collector is used as a negative electrode current collector, a material that does not alloy with carrier ions of lithium or the like is preferably used as a metal material that is used as the conductive material.

Note that the average particle diameter of the conductive material contained in the rubber-like current collector can be greater than or equal to 10 nm and less than or equal to 10 μm, and is preferably greater than or equal to 30 nm and less than or equal to 5 μm.

The thickness of the rubber-like current collector is preferably greater than or equal to 5 μm and less than or equal to 200 μm, further preferably greater than or equal to 5 μm and less than or equal to 100 μm, still further preferably greater than or equal to 5 μm and less than or equal to 50 μm, yet further preferably greater than or equal to 5 μm and less than or equal to 30 μm.

### <Method for Forming Rubber-Like Current Collector>

The rubber-like current collector can be formed by mixing and processing a raw material of the above-described rubber material (also referred to as a raw rubber material) and the above-described conductive material into a sheet-like shape, for example. In the case where heating is necessary for cross-linking molecules of the raw rubber material, heat treatment is preferably performed after the processing into a sheet-like shape. Note that after the rubber-like current collector is formed, a support (such as a resin sheet) may be provided until an active material layer is formed over the rubber-like current collector.

### <Binder>

As the binder, any one or more rubber materials selected from styrene-butadiene rubber, styrene-isoprene-styrene rubber, acrylonitrile-butadiene rubber, butadiene rubber, ethylene-propylene-diene copolymer, butyl rubber, ethylene-propylene rubber, fluororubber, silicone rubber, and urethane rubber is preferably used, for example. The above-described rubber material dispersed in a dispersion medium can be used. For example, one kind or two or more kinds of water, N-methylpyrrolidone (NMP), methanol, ethanol, acetone, tetrahydrofuran (THF), dimethylformamide (DMF), and dimethyl sulfoxide (DMSO) can be used as the dispersion medium.

As the binder, for example, water-soluble polymers can also be used. As the water-soluble polymers, a polysaccharide can be used, for example. As the polysaccharide, a cellulose derivative such as carboxymethyl cellulose (CMC), methyl cellulose, ethyl cellulose, hydroxypropyl cellulose, diacetyl cellulose, or regenerated cellulose, starch, or the like can be used. It is preferable that such a water-soluble polymer be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose may be used.

Two or more of the above materials may be used in combination for the binder.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, the above-mentioned polysaccharide or, for instance, a cellulose derivative such as carboxymethyl cellulose (CMC), methyl cellulose, ethyl cellulose, hydroxypropyl cellulose, diacetyl cellulose, or regenerated cellulose or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material or other components in the formation of slurry for an electrode. In this specification and the like, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, a “passivation film” refers to a film without electric conductivity or a film with extremely low electric conductivity, and can inhibit the decomposition of an electrolyte solution at a potential at which a battery reaction occurs when the passivation film is formed on the active material surface, for example. It is further desirable that the passivation film can conduct lithium ions while inhibiting electrical conduction.

### <Negative Electrode Active Material>

As the negative electrode active material, for example, a carbon material or an alloy-based material can be used.

As the carbon material, for example, graphite (natural graphite and artificial graphite), graphitizing carbon (soft carbon), non-graphitizing carbon (hard carbon), carbon fiber (carbon nanotube), graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are inserted into graphite (while a lithium-graphite intercalation compound is formed). For this reason, a lithium-ion battery using graphite can have a high operating voltage. In addition, graphite is preferred because of its advantages such as a relatively high capacity per unit volume, relatively small volume expansion, low cost, and a higher level of safety than that of a lithium metal.

Non-graphitizing carbon can be obtained by baking a synthetic resin such as a phenol resin, and an organic substance of plant origin, for example. In non-graphitizing carbon contained in the negative electrode active material of the lithium-ion battery of one embodiment of the present invention, the interplanar spacing of a (002) plane, which is measured by X-ray diffraction (XRD), is preferably greater than or equal to 0.34 nm and less than or equal to 0.50 nm, further preferably greater than or equal to 0.35 nm and less than or equal to 0.42 nm.

As the negative electrode active material, an element that enables charge and discharge reactions by alloying and dealloying reactions with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by alloying and dealloying reactions with lithium and a compound containing the element, for example, are referred to as alloy-based materials in some cases.

In this specification and the like, “SiO” refers, for example, to silicon monoxide. SiO can alternatively be expressed as SiOₓ. Here, it is preferable that x be 1 or have an approximate value of 1. For example, x is preferably greater than or equal to 0.2 and less than or equal to 1.5, or preferably greater than or equal to 0.3 and less than or equal to 1.2.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M=Co, Ni, or Cu) with a Li₃N structure, which is a composite nitride of lithium and a transition metal, can be used. For example, Li_{2.6}Co_{0.4}N₃ is preferable because of its high discharge capacity (900 mAh/g and 1890 mAh/cm³).

A composite nitride of lithium and a transition metal is preferably used, in which case lithium ions are contained in the negative electrode active material and thus the negative electrode active material can be used in combination with a positive electrode active material that does not contain lithium ions, such as V₂O₅ or Cr₃O₈. Note that in the case of using a material containing lithium ions as a positive electrode active material, the composite nitride of lithium and a transition metal can be used as the negative electrode active material by extracting the lithium ions contained in the positive electrode active material in advance.

A material that causes a conversion reaction can be used for the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂₀₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

Note that one kind or a combination of various kinds of the negative electrode active materials described above can be used. For example, a combination of a carbon material and silicon or a combination of a carbon material and silicon monoxide can be used.

As another mode of the negative electrode, a negative electrode that does not contain a negative electrode active material after completion of the fabrication of the battery may be used. The negative electrode that does not contain a negative electrode active material can be, for example, a negative electrode in which only a negative electrode current collector is included after completion of the fabrication of the battery and in which lithium ions extracted from the positive electrode active material due to charging of the battery are deposited as a lithium metal over the negative electrode current collector and form the negative electrode active material layer. A battery including such a negative electrode is referred to as a negative electrode-free (anode-free) battery, a negative electrodeless (anodeless) battery, or the like in some cases.

In the case where the negative electrode that does not contain a negative electrode active material is used, a film for making lithium deposition uniform may be provided over the negative electrode current collector. For the film for making lithium deposition uniform, for example, a solid electrolyte having lithium ion conductivity can be used. As the solid electrolyte, a sulfide-based solid electrolyte, an oxide-based solid electrolyte, a polymer-based solid electrolyte, or the like can be used. In particular, the polymer-based solid electrolyte can be uniformly formed as a film over the negative electrode current collector relatively easily, and thus is suitable for the film for making lithium deposition uniform. As another film for making lithium deposition uniform, for example, a metal film that forms an alloy with lithium can be used. As the metal film that forms an alloy with lithium, for example, a magnesium metal film can be used. It is suitable for the film for making lithium deposition uniform because lithium and magnesium form a solid solution in a wide range of compositions.

In the case where the negative electrode that does not contain a negative electrode active material is used, a negative electrode current collector having projections and depressions can be used. In the case where the negative electrode current collector having projections and depressions is used, a depression of the negative electrode current collector becomes a cavity in which lithium contained in the negative electrode current collector is easily deposited, so that the lithium can be inhibited from having a dendrite-like shape when being deposited.

### <Conductive Material>

A conductive material is also referred to as a conductivity-imparting agent or a conductive additive, and a carbon material is used. A conductive material is attached between a plurality of active materials, whereby the plurality of active materials are electrically connected to each other, and the conductivity increases. Note that the term “attach” refers not only to a state where an active material and a conductive material are physically in close contact with each other, and includes, for example, the following concepts: the case where covalent bonding occurs, the case where bonding with the Van der Waals force occurs, the case where a conductive material covers part of an active material surface, the case where a conductive material is embedded in projections and depressions of an active material surface, and the case where an active material and a conductive material are electrically connected to each other without being in contact with each other.

An active material layer such as the positive electrode active material layer or the negative electrode active material layer preferably contains a conductive material.

As the conductive material, for example, any one kind or two or more kinds of carbon black such as acetylene black or furnace black, graphite such as artificial graphite or natural graphite, fiber such as carbon nanofiber or carbon nanotube, and a graphene compound can be used.

As the carbon fiber, for example, carbon fiber such as mesophase pitch-based carbon fiber or isotropic pitch-based carbon fiber can be used. Carbon nanofiber, carbon nanotube, or the like can also be used as the carbon fiber. Carbon nanotube can be formed by, for example, a vapor deposition method.

A graphene compound in this specification and the like refers to graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound is preferably curved. The graphene compound may be rounded like a carbon nanofiber.

The active material layer may contain, as a conductive material, metal powder or metal fiber of copper, nickel, aluminum, silver, gold, or the like, a conductive ceramic material, or the like.

The content of the conductive material with respect to the total amount of the active material layer is preferably greater than or equal to 1 wt % and less than or equal to 10 wt %, further preferably greater than or equal to 1 wt % and less than or equal to 5 wt %.

Unlike a particulate conductive material such as carbon black, which makes point contact with an active material, a graphene compound is capable of making low-resistance surface contact; accordingly, the electrical conduction between the particulate active material and the graphene compound can be improved with a smaller amount of the graphene compound than that of a normal conductive material. This can increase the proportion of the active material in the active material layer. Accordingly, the discharge capacity of a battery can be increased.

A particulate carbon-containing compound such as carbon black or graphite or a fibrous carbon-containing compound such as carbon nanotube easily enters a microscopic space. A microscopic space means, for example, a region or the like between a plurality of active materials. When a carbon-containing compound that easily enters a microscopic space and a sheet-like carbon-containing compound, such as graphene, that can impart conductivity to a plurality of particles are used in combination, the density of the electrode is increased and an excellent conductive path can be formed. The battery obtained by the manufacturing method of one embodiment of the present invention can have high capacity density and stability, and is effective as an in-vehicle battery.

### [Positive Electrode]

A positive electrode includes a positive electrode active material layer and a positive electrode current collector. The positive electrode active material layer contains a positive electrode active material and may further contain at least one of a conductive material and a binder. Note that the positive electrode current collector, the conductive material, and the binder described in [Negative electrode] can be used.

As the positive electrode current collector, any of the above-described rubber-like current collectors can be used. The positive electrode can be formed by applying slurry onto a current collector and drying the slurry. Note that pressing may be performed after drying. The positive electrode is obtained by forming an active material layer over the current collector.

Slurry refers to a material solution that is used to form an active material layer over a current collector and includes an active material, a binder, and a solvent, preferably also a conductive material mixed therewith. Slurry may also be referred to as slurry for an electrode or active material slurry; in some cases, slurry for forming a positive electrode active material layer is referred to as slurry for a positive electrode.

### <Positive Electrode Active Material>

As the positive electrode active material, one or more of a composite oxide having a layered rock-salt structure, a composite oxide having an olivine structure, and a composite oxide having a spinel structure can be used.

As the composite oxide having a layered rock-salt structure, one or more of lithium cobalt oxide, lithium nickel-cobalt-manganese oxide, lithium nickel-cobalt-aluminum oxide, and lithium nickel-manganese-aluminum oxide can be used. Note that the composition formula can be represented by LiM1O₂ (M1 is one or more selected from nickel, cobalt, manganese, and aluminum), and a coefficient of the composition formula is not limited to an integer.

As the lithium cobalt oxide, for example, lithium cobalt oxide to which magnesium and fluorine are added can be used. It is preferable to use lithium cobalt oxide to which magnesium, fluorine, aluminum, and nickel are added.

As the lithium nickel-cobalt-manganese oxide, for example, lithium nickel-cobalt-manganese oxide with a ratio such as nickel:cobalt:manganese=1:1:1, 6:2:2, 8:1:1, or 9:0.5:0.5 can be used. As the above-described lithium nickel-cobalt-manganese oxide, for example, lithium nickel-cobalt-manganese oxide to which one or more of aluminum, calcium, barium, strontium, and gallium are added is preferably used.

As the composite oxide having an olivine structure, one or more of lithium iron phosphate, lithium manganese phosphate, lithium cobalt phosphate, and lithium iron manganese phosphate can be used. Note that the composition formula can be represented by LiM2PO₄ (M2 is one or more selected from iron, manganese, and cobalt), and a coefficient of the composition formula is not limited to an integer.

Furthermore, composite oxide having a spinel structure, e.g., LiMn₂O₄, can be used.

### [Electrolyte]

An example of an electrolyte is described below. As one mode of the electrolyte, a liquid electrolyte (also referred to as an electrolyte solution) containing a solvent and an electrolyte dissolved in the solvent can be used. The electrolyte is not limited to a liquid electrolyte (an electrolyte solution) that is liquid at normal temperature, and a solid electrolyte can be used as well. Alternatively, an electrolyte including both a liquid electrolyte that is liquid at normal temperature and a solid electrolyte that is a solid at normal temperature (such an electrolyte is referred to as a semi-solid electrolyte) can also be used. Note that when the solid electrolyte or the semi-solid electrolyte is used for a bendable battery, part of a stack in the battery includes the electrolyte, whereby the battery can maintain the flexibility.

In the case where a liquid electrolyte is used for a secondary battery, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more thereof can be used in an appropriate combination at an appropriate ratio, for example.

Alternatively, the use of one or more of ionic liquids (normal temperature molten salts) which have features of non-flammability and non-volatility as a solvent of the electrolyte can prevent a secondary battery from exploding or catching fire even when an internal region of a secondary battery shorts out or the temperature in the internal region increases owing to overcharging or the like. An ionic liquid contains a cation and an anion, specifically, an organic cation and an anion. Examples of the organic cation include aliphatic onium cations such as a quaternary ammonium cation, a tertiary sulfonium cation, and a quaternary phosphonium cation, and aromatic cations such as an imidazolium cation and a pyridinium cation. Examples of the anion include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

The secondary battery of one embodiment of the present invention includes, as a carrier ion, an alkali metal ion such as a lithium ion, a sodium ion, or a potassium ion or an alkaline earth metal ion such as a calcium ion, a strontium ion, a barium ion, a beryllium ion, or a magnesium ion, for example.

In the case where lithium ions are used as carrier ions, the electrolyte contains lithium salt, for example. As the lithium salt, LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), LiN(C₂F₅SO₂)₂, or the like can be used, for example.

For example, an organic solvent described in this embodiment contains ethylene carbonate (EC), ethyl methyl carbonate (EMC), and dimethyl carbonate (DMC). When the total content of the ethylene carbonate, the ethyl methyl carbonate, and the dimethyl carbonate is set to 100 vol %, an organic solvent in which the volume ratio between the ethylene carbonate, the ethyl methyl carbonate, and the dimethyl carbonate is x:y:100−x−y (where 5≤x≤35 and 0<y<65) can be used. More specifically, an organic solvent containing EC, EMC, and DMC at EC:EMC:DMC=30:35:35 (volume ratio) can be used.

The electrolyte solution is preferably highly purified and contains a small amount of dust particles and elements other than the constituent elements of the electrolyte solution (hereinafter, also simply referred to as “impurities”). Specifically, the weight ratio of impurities to the electrolyte solution is preferably less than or equal to 1%, further preferably less than or equal to 0.1%, still further preferably less than or equal to 0.01%.

In order to form a coating film (Solid Electrolyte Interphase) at the interface between an electrode (active material layer) and the electrolyte solution for the purpose of improvement of the safety or the like, an additive agent such as vinylene carbonate (VC), propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of such an additive agent in the solvent is, for example, higher than or equal to 0.1 wt % and lower than or equal to 5 wt %.

When a high-molecular material that can gel is contained in the electrolyte, safety against liquid leakage and the like is improved. Typical examples of the gelled high-molecular material include a silicone gel, an acrylic gel, an acrylonitrile gel, a polyethylene oxide-based gel, a polypropylene oxide-based gel, and a gel of a fluorine-based polymer.

As the high-molecular material, for example, a polymer having a polyalkylene oxide structure, such as polyethylene oxide (PEO); PVDF; polyacrylonitrile; a copolymer containing any of them; and the like can be used. For example, PVDF-HFP, which is a copolymer of PVDF and hexafluoropropylene (HFP), can be used. The formed polymer may be porous.

### [Separator]

When the electrolyte includes an electrolyte solution, a separator is placed between the positive electrode and the negative electrode. The separator can be formed using, for example, fiber containing cellulose, such as paper, nonwoven fabric, glass fiber, ceramics, or synthetic fiber containing nylon (polyamide), polyimide vinylon (polyvinyl alcohol-based fiber), polyester, acrylic, polyolefin, or polyurethane. The separator is preferably processed into a bag-like shape to wrap one of the positive electrode and the negative electrode.

The separator may have a multilayer structure. For example, an organic material film of polypropylene, polyethylene, or the like can be coated with a ceramic-based material, a fluorine-based material, a poly amide-based material, a polyimide-based material, a mixture thereof, or the like. Examples of the ceramic-based material include aluminum oxide particles (e.g., alumina and boehmite) and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, degradation of the separator during high-voltage charging and discharging can be inhibited and thus the reliability of the battery can be improved. When the separator is coated with the fluorine-based material, the separator is easily brought into close contact with an electrode, resulting in high output characteristics. When the separator is coated with the polyamide-based material, in particular, aramid, heat resistance can be improved to improve the safety of the battery.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With use of a separator having a multilayer structure, the capacity per volume of the battery can be increased because the safety of the battery can be maintained even when the total thickness of the separator is small.

### [Example of Electrode Stack]

A structure example of a stack including a plurality of electrodes will be described below.

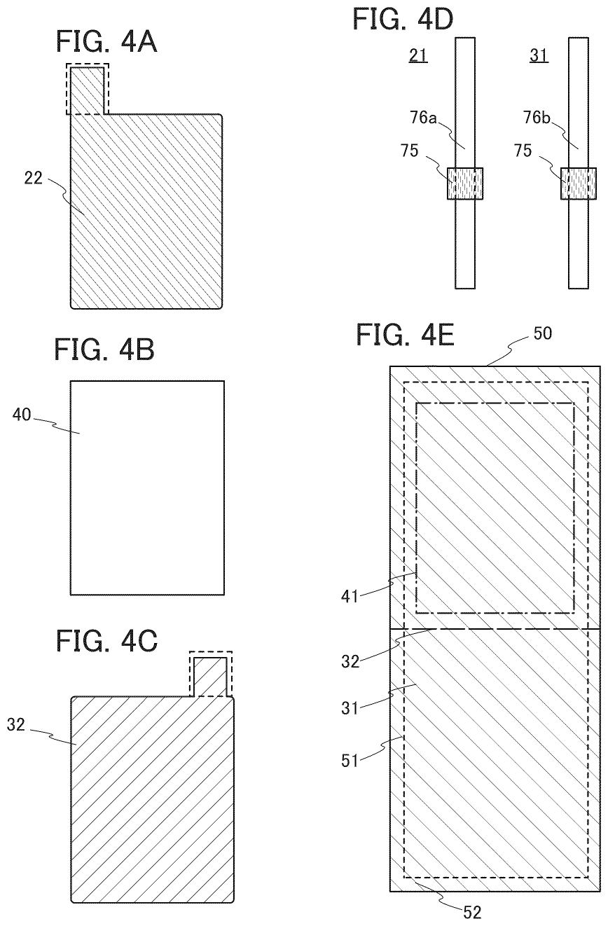

FIG. 4A illustrates a top view of the positive electrode current collector 22, FIG. 4B illustrates a top view of the separator 40, FIG. 4C illustrates a top view of the negative electrode current collector 32, FIG. 4D illustrates a top view of the positive electrode lead 21 and the negative electrode lead 31, and FIG. 4E illustrates a top view of the film-like exterior body 50. The positive electrode lead 21 includes a sealing portion 75 and a lead metal 76a, and the negative electrode lead 31 includes the sealing portion 75 and a lead metal 76b.

The dimensions in the drawings of FIG. 4 are substantially the same, and a region 41 surrounded by a dashed-dotted line in FIG. 4E has substantially the same dimensions as the separator in FIG. 4B. A region between a dashed line and the edge in FIG. 4E becomes the sealing portion 51 and the sealing portion 52.

The protruding portion of the positive electrode current collector 22 (a dashed line portion in FIG. 4A) and the protruding portion of the negative electrode current collector 32 (a dashed line portion in FIG. 4C) are referred to as tab portions.

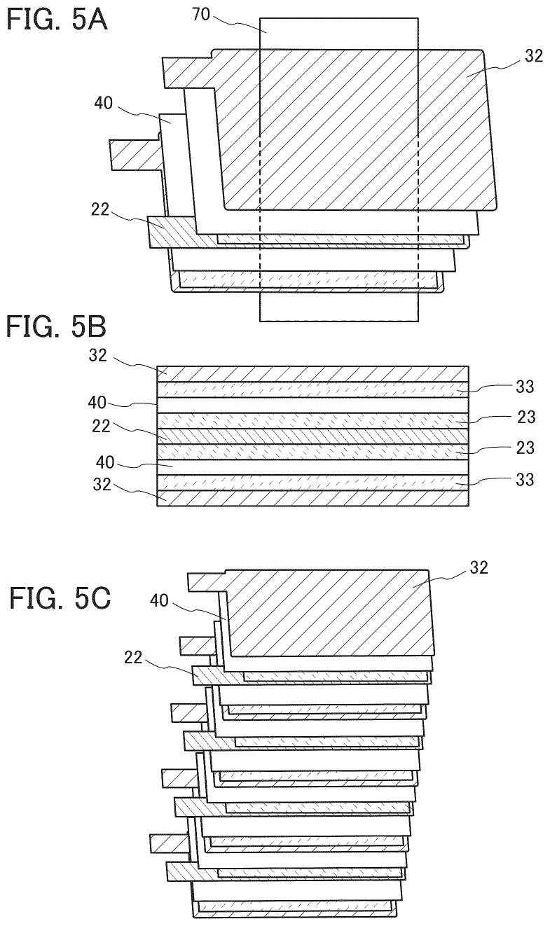

FIG. 5A is an example in which the positive electrode active material layers 23 are provided on both surfaces of the positive electrode current collector 22. Specifically, the negative electrode current collector 32, the negative electrode active material layer 33, the separator 40, the positive electrode active material layer 23, the positive electrode current collector 22, the positive electrode active material layer 23, the separator 40, the negative electrode active material layer 33, and the negative electrode current collector 32 are stacked in this order. FIG. 5B illustrates a cross-sectional view of the stacked-layer structure taken along a plane 70.

Although FIG. 5A illustrates an example in which two separators are used, a structure may be employed in which one separator is folded and both ends are sealed to form a bag-like shape, and the positive electrode current collector 22 is held therein. The positive electrode active material layers 23 are formed on both surfaces of the positive electrode current collector 22 held in the separator having a bag-like shape.

The negative electrode active material layers 33 can be provided on both surfaces of the negative electrode current collector 32. FIG. 5C illustrates an example of a secondary battery in which three negative electrode current collectors 32 each provided with the negative electrode active material layers 33 on both surfaces, four positive electrode current collectors 22 each provided with the positive electrode active material layers 23 on both surfaces, and eight separators 40 are sandwiched between two negative electrode current collectors 32 each provided with the negative electrode active material layer 33 on one surface. In this case, four separators each having a bag-like shape may be used instead of eight separators.

The capacity of the secondary battery can be increased by increasing the number of stacks. In addition, when the positive electrode active material layers 23 are provided on both surfaces of the positive electrode current collector 22 and the negative electrode active material layers 33 are provided on both surfaces of the negative electrode current collector 32, the thickness of the secondary battery can be made small.

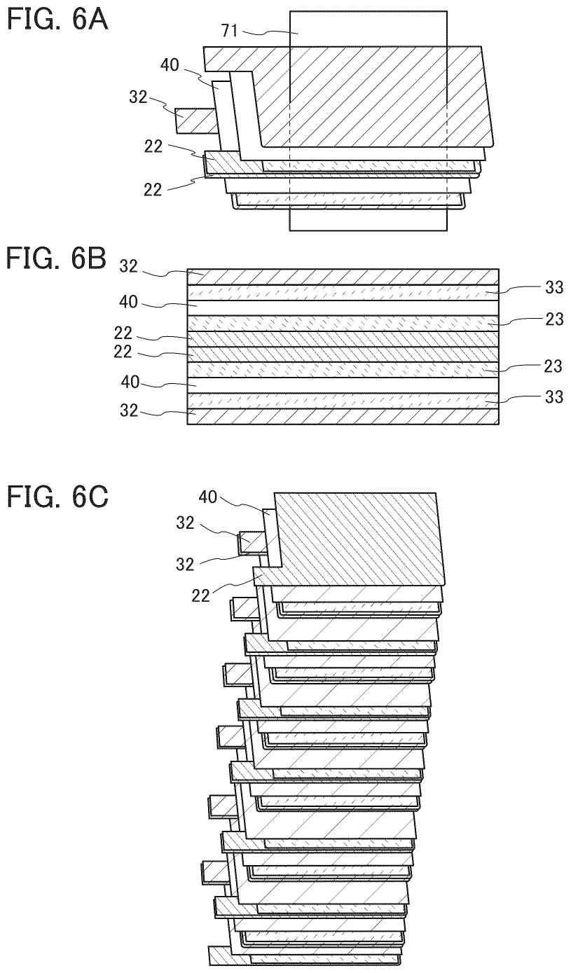

FIG. 6A illustrates a diagram of a secondary battery in which the positive electrode active material layer 23 is provided on one surface of the positive electrode current collector 22 and the negative electrode active material layer 33 is provided on one surface of the negative electrode current collector 32. Specifically, the negative electrode active material layer 33 is provided on one surface of the negative electrode current collector 32 and the separator 40 is stacked in contact with the negative electrode active material layer 33. The positive electrode active material layer 23 provided on one surface of the positive electrode current collector 22 is in contact with the surface of the separator 40 that is not in contact with the negative electrode active material layer 33. Another positive electrode current collector 22 whose one surface is provided with the positive electrode active material layer 23 is in contact with the surface of the positive electrode current collector 22. In that case, the positive electrode current collectors 22 are provided such that the surfaces not provided with the positive electrode active material layers 23 face each other. Then, another separator 40 is formed, and the negative electrode active material layer 33 provided on one surface of the negative electrode current collector 32 is stacked in contact with the separator. FIG. 6B illustrates a cross-sectional view of the stacked-layer structure in FIG. 6A taken along a plane 71.

Although two separators are used in FIG. 6A, a structure may be employed in which one separator is folded and both ends are sealed to form a bag-like shape, and two positive electrode current collectors 22 each provided with the positive electrode active material layer 23 on one surface are sandwiched therebetween.

FIG. 6C illustrates a diagram in which a plurality of the stacked-layer structures each illustrated in FIG. 6A are stacked. In FIG. 6C, the negative electrode current collectors 32 are provided such that the surfaces not provided with the negative electrode active material layers 33 face each other. FIG. 6C illustrates a state where twelve positive electrode current collectors 22, twelve negative electrode current collectors 32, and twelve separators 40 are stacked.

A secondary battery with a stacked-layer structure in which the positive electrode active material layer 23 is provided on one surface of the positive electrode current collector 22 and the negative electrode active material layer 33 is provided on one surface of the negative electrode current collector 32 has a larger thickness than a secondary battery with a structure in which the positive electrode active material layers 23 are provided on both surfaces of the positive electrode current collector 22 and the negative electrode active material layers 33 are provided on both surfaces of the negative electrode current collector 32. However, the surface of the positive electrode current collector 22 on which the positive electrode active material layer 23 is not provided faces the surface of another positive electrode current collector 22 on which the positive electrode active material layer 23 is not provided; as a result, the current collectors are in contact with each other. Similarly, the surface of the negative electrode current collector 32 on which the negative electrode active material layer 33 is not provided faces the surface of another negative electrode current collector 32 on which the negative electrode active material layer 33 is not provided; as a result, the current collectors are in contact with each other. For example, in the case where treatment for improving slidability is performed on the surface of the positive electrode current collector 22 on which the positive electrode active material layer 23 is not provided and/or the surface of the negative electrode current collector 32 on which the negative electrode active material layer 33 is not provided, friction force on the contact surfaces of the current collectors is not so strong and the contact surfaces of the current collectors can easily slide on each other. That is, the current collectors in the secondary battery slide on each other at the time of bending the secondary battery; thus, the secondary battery can be easily bent. As the treatment for improving slidability which is performed on the current collectors, fluororesin (e.g., polytetrafluoroethylene) coating, graphene coating, graphene compound coating, carbon nanotube coating, or the like can be used, for example.

The plurality of positive electrode current collectors 22 are stacked as illustrated in FIG. 5 and FIG. 6 and are all fixed and electrically connected to each other. Similarly, the plurality of negative electrode current collectors 32 are all fixed and electrically connected to each other.

Here, it is preferable that the positive electrode lead 21 and the plurality of positive electrode current collectors 22 be fixed and electrically connected to each other at the same time. Similarly, it is preferable that the negative electrode lead 31 and the plurality of negative electrode current collectors 32 be fixed and electrically connected to each other at the same time. When a plurality of current collectors and an electrode lead are connected at the same time in this manner, fabrication can be performed efficiently.

As a method for fixing a plurality of current collectors and an electrode lead, it is possible to use a fixing method by adhesion using a conductive resin (also referred to as a conductive adhesive), a fixing method by holding a plurality of current collectors and an electrode lead with a fixing member, a fixing method by embedding metal foil in a tab portion so as to expose the metal foil at the time of forming a rubber-like current collector and performing welding such as ultrasonic welding on the exposed portion of the metal foil, or the like.

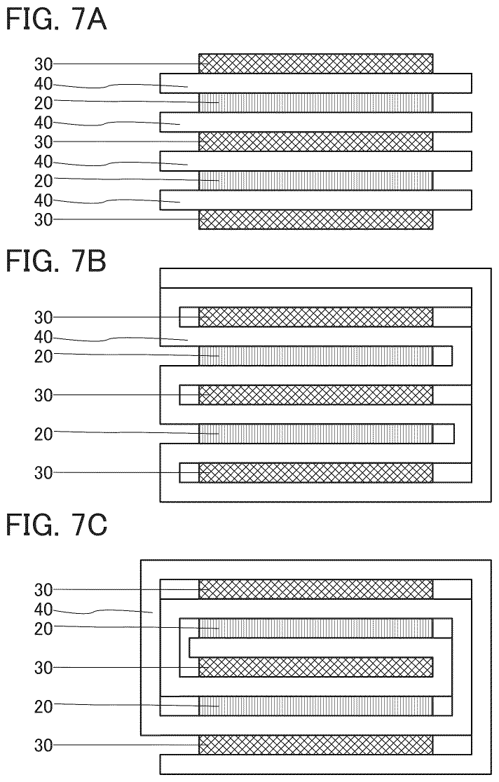

The separators 40 preferably have a shape that helps prevent an electrical short circuit between the positive electrode 20 and the negative electrode 30. For example, the width of each of the separators 40 is preferably larger than those of the positive electrode 20 and the negative electrode 30 as illustrated in FIG. 7A, in which case the positive electrode 20 and the negative electrode 30 are less likely to come in contact with each other even when the relative positions thereof are shifted because of a change in shape such as bending. As illustrated in FIG. 7B, one separator 40 is preferably folded into an accordion-like shape, or as illustrated in FIG. 7C, one separator 40 is preferably wrapped around the positive electrodes 20 and the negative electrodes 30 alternately, in which case the positive electrode 20 and the negative electrode 30 do not come in contact with each other even when the relative positions thereof are shifted. FIG. 7B and FIG. 7C each illustrate an example in which the separator 40 is provided to partly cover the side surface of a stacked-layer structure of the positive electrodes 20 and the negative electrodes 30.

Although the drawings of FIG. 7 do not illustrate details of the positive electrode 20 and the negative electrode 30, the above description can be referred to for formation methods thereof. Although an example in which the positive electrodes 20 and the negative electrodes 30 are alternately arranged is described here, two positive electrodes 20 or two negative electrodes 30 may be adjacent to each other as in FIG. 6.

Although a structure example in which one rectangle film is folded in half and two end portions are made to overlap with each other for sealing is described in this embodiment, the shape of the film is not limited to a rectangle. A polygon such as a triangle, a square, or a pentagon or any symmetric shape other than a rectangle, such as a circle or a star, may be employed.

### [Exterior Body]

For an exterior body included in the battery, a resin material or a metal material such as aluminum, stainless steel, or titanium can be used, for example. A film-like exterior body can also be used. As the film, for example, it is possible to use a film having a three-layer structure in which a highly flexible metal thin film or metal foil of aluminum, stainless steel, titanium, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body. Such a film with a multilayer structure can be referred to as a laminated film. At this time, the laminated film is sometimes referred to as an aluminum laminated film, a stainless steel laminated film, a titanium laminated film, a copper laminated film, a nickel laminated film, or the like using the material name of the metal layer included in the laminated film.

The material or thickness of the metal layer included in the laminated film sometimes affects the flexibility of a battery. As an exterior body used for a highly flexible (bendable) battery, for example, an aluminum laminated film including a polypropylene layer, an aluminum layer, and nylon is preferably used. Here, the thickness of the aluminum layer is preferably smaller than or equal to 50 μm, further preferably smaller than or equal to 40 μm, still further preferably smaller than or equal to 30 μm, yet further preferably smaller than or equal to 20 μm. Note that in the case where the thickness of the aluminum layer is smaller than 10 μm, a gas barrier property might be lowered by pinholes of the aluminum layer; thus, the thickness of the aluminum layer is desirably larger than or equal to 10 μm.

A graphene sheet may be substituted for the above metal layer of the laminated film. As the graphene sheet, a multilayer graphene sheet with a thickness greater than or equal to 100 nm and less than or equal to 30 μm, preferably greater than or equal to 200 nm and less than or equal to 20 μm can be used. The graphene sheet is flexible and has a gas barrier property with the interlayer distance of graphene of 0.34 nm and thus is suitable as a film used for the exterior body of the secondary battery.

[Processing Method of Film with Projections and Depressions]

Next, a processing method of a film that can be used for the exterior body 50 will be described. The laminated film described above can be used as the film.

As the laminated film, a stacked-layer film can be used, for example. As the stacked-layer film, for example, a metal film including a heat-seal layer on one surface or both surfaces can be used. As an adhesive layer, a heat-seal resin film containing polypropylene, polyethylene, or the like can be used. In this embodiment, an aluminum laminated film in which a surface of aluminum foil is provided with a nylon resin and the rear surface of the aluminum foil is provided with a stack of an acid-proof polypropylene film and a polypropylene film is used.

Then, the film is embossed. As a result, the film having projections and depressions can be formed. The film includes a plurality of projections and depressions, thereby having a wave pattern that can be visually recognized.

Embossing, which is a kind of pressing, will be described below.

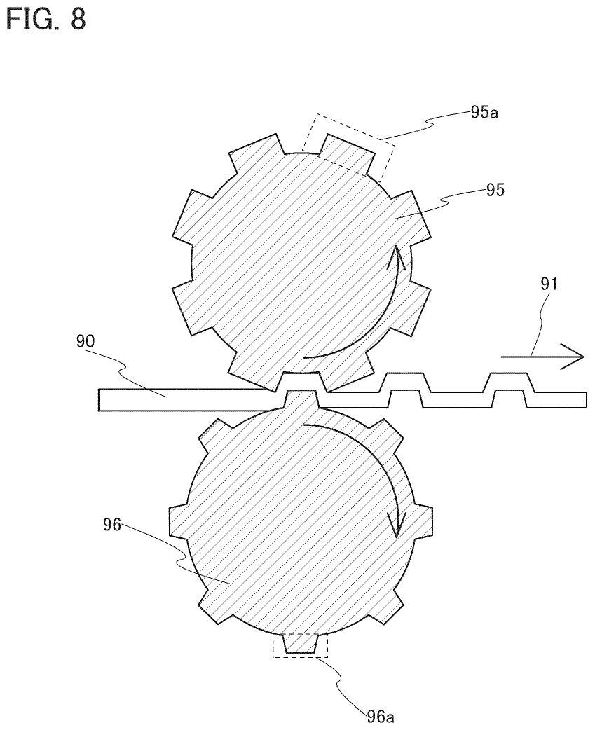

FIG. 8 is a cross-sectional view illustrating an example of embossing. Note that embossing, which is a kind of pressing, refers to processing for forming projections and depressions corresponding to projections and depressions of an embossing roll on a film by bringing the embossing roll whose surface has projections and depressions into contact with the film with pressure. Note that the embossing roll is a roll whose surface is patterned.

FIG. 8 illustrates an example in which both surfaces of a film are embossed. FIG. 8 illustrates a forming method of a film having projections whose top portions are on one surface side.

FIG. 8 illustrates the state where a film 90 is sandwiched between an embossing roll 95 in contact with one surface of the film and an embossing roll 96 in contact with the other surface and the film 90 is being transferred in a direction 91. The surface of the film is patterned by pressure or heat. The surface of the film may be patterned by pressure and heat.

As the embossing roll, a metal roll, a ceramic roll, a plastic roll, a rubber roll, an organic resin roll, a lumber roll, or the like can be used as appropriate.

In FIG. 8, embossing is performed using the male embossing roll 96 and the female embossing roll 95. The male embossing roll 96 has a plurality of projections 96a. The projections correspond to projections formed on a film to be processed. The female embossing roll 95 has a plurality of projections 95a. Between adjacent projections 95a, a depression is positioned into which a projection formed on the film by the projection 96a of the male embossing roll 96 fits.

Successive embossing by which the film 90 partly stands out and debossing by which the film 90 is partly indented can form a projection and a flat portion successively. In this manner, a pattern can be formed on the film 90.

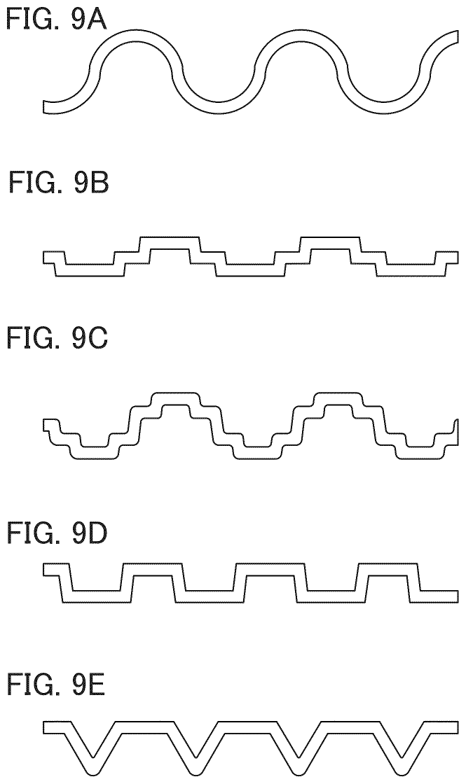

Next, a film having a plurality of projections with a shape different from that in FIG. 8 is described with reference to FIG. 9A to FIG. 9E. The shape of projections of the embossing roll 95 and the embossing roll 96 in FIG. 8 is changed to a shape different from that in FIG. 8, whereby embossing into various cross-sectional shapes illustrated in FIG. 9A to FIG. 9E can be performed.

FIG. 9A is a schematic cross-sectional view of an embossment having a wave shape, and FIG. 9B to FIG. 9E are modification examples of FIG. 9A. FIG. 9B and FIG. 9C are diagrams illustrating examples of forming a stepwise wave shape, FIG. 9D is a diagram illustrating an example of forming a rectangular wave shape, and FIG. 9E is a diagram illustrating an example of forming a wave shape with acute troughs and trapezoidal crests.

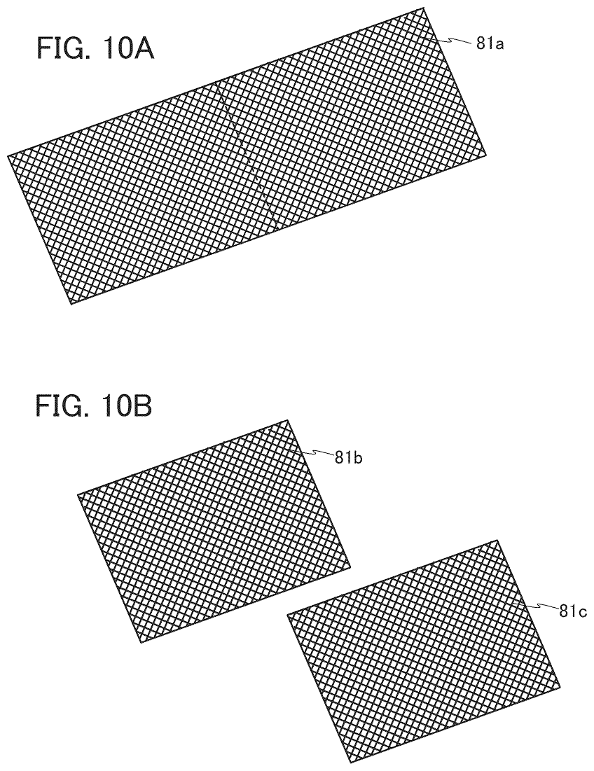

FIG. 10A and FIG. 10B are bird's eye views illustrating the completed shapes obtained by performing the embossing illustrated in FIG. 8 to FIG. 9E twice with different orientations of the film 90. Specifically, embossing is performed on the film 90 in a first direction, and then embossing is performed on the film 90 in a second direction that is rotated 90° with respect to the first direction, whereby a film having an embossed shape (also referred to as an alternating wave shape) illustrated in FIG. 10A and FIG. 10B can be obtained. Note that when a secondary battery is fabricated using one film 81a, the film 81a having an alternating wave shape has an external shape illustrated in FIG. 10A and can be used by being folded in two along a dashed line portion. When a secondary battery is fabricated using two films (a film 81b and a film 81c), the plurality of films (the film 81b and the film 81c) each having an alternating wave shape have an external shape illustrated in FIG. 10B, and the film 81b and the film 81c can overlap with each other to be used.

When processing is performed using the embossing rolls in the aforementioned manner, an apparatus can be small. Furthermore, a film before being cut can be processed, achieving excellent mass productivity. Note that a film processing method is not limited to processing using embossing rolls; a film may be processed by pressing a pair of embossing plates having a surface with projections and depressions against the film. In that case, one of the embossing plates may be flat and the film may be processed in a plurality of steps.

In the above-described structure example of the secondary battery, the example is described in which the exterior body on one surface of the secondary battery and the exterior body on the other surface thereof have the same embossed shape; however, the structure of the secondary battery of one embodiment of the present invention is not limited thereto. For example, a secondary battery one surface of which is provided with an exterior body having an embossed shape and the other surface of which is provided with an exterior body not having an embossed shape can be used. Alternatively, the exterior body on one surface of the secondary battery and the exterior body on the other surface thereof may have different embossed shapes.

This embodiment can be implemented in appropriate combination with the other embodiments.

### Embodiment 2

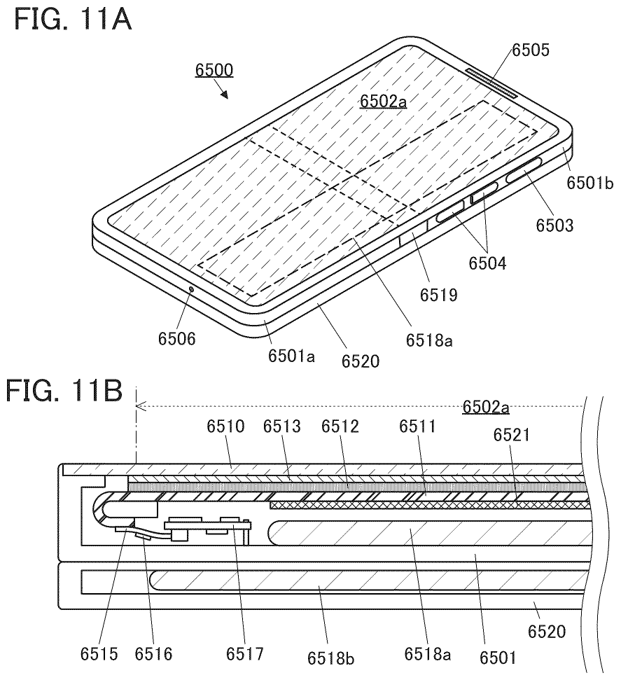

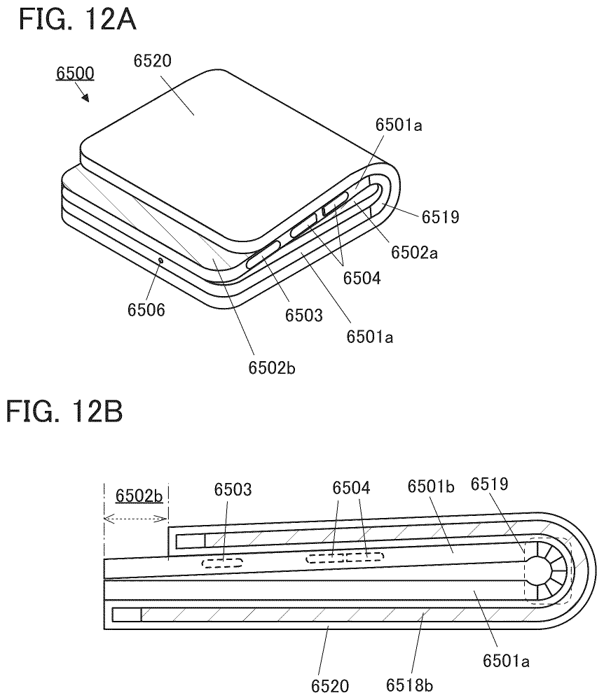

In this embodiment, an electronic device including the secondary battery 10 of one embodiment of the present invention will be described with reference to FIG. 11 and FIG. 12.

An electronic device 6500 illustrated in FIG. 11A is a portable information terminal that can be used as a smartphone.

The electronic device 6500 includes at least a first housing 6501a, a second housing 6501b, a hinge portion 6519, a display portion 6502a, a power button 6503, buttons 6504, a speaker 6505, and a microphone 6506. The display portion 6502a has a touch panel function. The first housing 6501a and the second housing 6501b are connected to each other through the hinge portion 6519.

The electronic device 6500 can be folded at the hinge portion 6519.

FIG. 11B is a schematic cross-sectional view including an end portion of a housing 6501 (6501a and 6501b) on the microphone 6506 side.

A protection member 6510 having a light-transmitting property is provided on the display surface side of the housing 6501 (6501a and 6501b), and a display panel 6511, an optical member 6512, a touch sensor panel 6513, a printed circuit board 6517, and a first battery 6518a are provided in a space surrounded by the housing 6501 (6501a and 6501b) and the protection member 6510.

The display panel 6511, the optical member 6512, and the touch sensor panel 6513 are fixed to the protection member 6510 with an adhesive layer (not illustrated).

Part of the display panel 6511 is folded back in a region outside the display portion 6502a, and an FPC 6515 is connected to the part that is folded back. An IC 6516 is mounted on the FPC 6515. The FPC 6515 is connected to a terminal provided on the printed circuit board 6517.

A flexible display can be used as the display panel 6511. The flexible display includes a plurality of flexible films and employs a plurality of light-emitting elements arranged in a matrix. As the light-emitting elements, EL elements (also referred to as EL devices) such as OLEDs or QLEDs are preferably used. Examples of alight-emitting substance contained in the EL element include a substance that emits fluorescent light (a fluorescent material), a substance that emits phosphorescent light (a phosphorescent material), an inorganic compound (a quantum dot material or the like), and a substance exhibiting thermally activated delayed fluorescence (a thermally activated delayed fluorescent (TADF) material). An LED such as a micro LED can also be used as the light-emitting element.

The use of the flexible display allows the display panel 6511 to be provided at a position overlapping with the first housing 6501a, the second housing 6501b, and the hinge portion 6519, and to be folded at the hinge portion 6519.

The use of the flexible display allows an internal space of the housing 6501 (6501a and 6501b) to be effectively utilized and an extremely lightweight electronic device to be achieved. Since the display panel 6511 is extremely thin, the first battery 6518a with high capacity can be mounted while the thickness of the electronic device is reduced.

Furthermore, in the electronic device 6500 using the high capacity battery, a second battery 6518b is provided inside a cover portion 6520 and is electrically connected to the first battery 6518a although the connection portion therebetween is not illustrated. The flexible battery of one embodiment of the present invention can be used as the first battery 6518a and the second battery 6518b.

The use of the flexible battery allows the battery to be provided at a position overlapping with the first housing 6501a, the second housing 6501b, and the hinge portion 6519, and to be folded at the hinge portion 6519.

Part of the display panel 6511 is folded back such that a connection portion with the FPC 6515 is provided on the rear side of the pixel portion, whereby an electronic device with a narrow bezel can be achieved.

When the flexible battery of one embodiment of the present invention is used as one or both of the first battery 6518a and the second battery 6518b, the electronic device 6500 can be partly folded to be downsized, so that the electronic device 6500 with high portability can be achieved.

FIG. 12A is a perspective view illustrating a folded state along the dotted line portion in FIG. 11A. The electronic device 6500 can be folded in half, the display portion 6502a and the second battery 6518b can be folded repeatedly.

FIG. 12A illustrates a structure in which a second display portion 6502b is provided in a portion exposed when the cover portion 6520 slides by folding. Even when the cover portion 6520 is folded in half, a user can check simple time display or e-mail reception notification display by seeing the second display portion 6502b.

FIG. 12B schematically illustrates a cross-sectional state of the cover portion in a state where the electronic device 6500 is folded. In FIG. 12B, the inside of the housing 6501 (6501a and 6501b) is not illustrated for simplicity.

In FIG. 12B, the hinge portion 6519 can be referred to as a connection portion and can have various modes as well as a structure example in which a plurality of columnar bodies are connected. It is particularly preferable that the hinge portion 6519 have a mechanism capable of curving the display portion 6502a and the second battery 6518b without stretching.

Although the second battery 6518b is illustrated inside the cover portion 6520, a plurality of second batteries may be included. In addition, a charging control circuit or a wireless charging circuit of the second battery 6518b may be provided inside the cover portion 6520.

In the example, the cover portion 6520 is partly fixed to the housing 6501 (6501a and 6501b) and is not fixed to a portion overlapping with the hinge portion 6519 and a portion overlapping with the second display portion 6502b that is exposed when the cover portion 6520 slides by folding.

The cover portion 6520 is not necessarily fixed to the housing 6501 (6501a and 6501b) and may be detachable. In the case where high capacity is not needed, the electronic device 6500 can be used while the cover portion 6520 is detached and the first battery 6518a is used. Charging of the detached second battery 6518b allows supplementary charging of the first battery 6518a when the second battery 6518b is reconnected to the first battery 6518a. Thus, the cover portion 6520 can also be used as a mobile battery.

FIG. 12A and FIG. 12B illustrate an example in which the display portion 6502a is folded in half such that the display surface faces inside; however, there is no particular limitation and the hinge portion 6519 may have a structure allowing the display portion 6502a to be folded in half such that the display surface faces outside.

The flexible battery of one embodiment of the present invention has high reliability with respect to repetitive deformation, and thus can be suitably used for the device that can be folded (also referred to as a foldable device).

At least part of this embodiment can be implemented in combination with the other embodiments described in this specification as appropriate.

### Embodiment 3

In this embodiment, examples of electronic devices each including the secondary battery 10 of one embodiment of the present invention as a flexible battery will be described. Examples of electronic devices each including a flexible battery include television sets (also referred to as televisions or television receivers), monitors of computers or the like, digital cameras, digital video cameras, digital photo frames, mobile phones (also referred to as cellular phones or mobile phone devices), portable game machines, portable information terminals, audio reproducing devices, and large game machines such as pachinko machines. Examples of the portable information terminals include laptop personal computers, tablet terminals, e-book readers, and mobile phones.

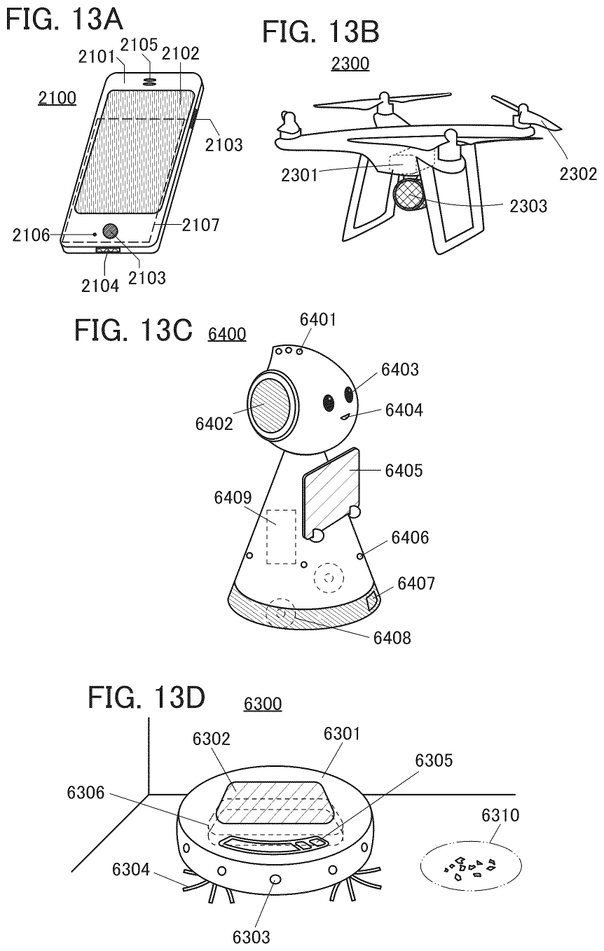

FIG. 13A illustrates an example of a mobile phone. A mobile phone 2100 is provided with a display portion 2102 incorporated in a housing 2101, operation buttons 2103, an external connection port 2104, a speaker 2105, a microphone 2106, and the like. Note that the mobile phone 2100 includes a flexible battery 2107. The flexible battery 2107 can be bent and thus can be mounted in a curved region of the mobile phone 2100.

The mobile phone 2100 is capable of executing a variety of applications such as mobile phone calls, e-mailing, text viewing and editing, music reproduction, Internet communication, and a computer game.

With the operation buttons 2103, a variety of functions such as time setting, power on/off, on/off of wireless communication, setting and cancellation of a silent mode, and setting and cancellation of a power saving mode can be performed. For example, the functions of the operation buttons 2103 can be set freely by an operating system incorporated in the mobile phone 2100.

The mobile phone 2100 can execute near field communication conformable to a communication standard. For example, mutual communication between the mobile phone 2100 and a headset capable of wireless communication enables hands-free calling.

The mobile phone 2100 includes the external connection port 2104, and can perform direct data transmission and reception with another information terminal via a connector. In addition, charging can be performed via the external connection port 2104. Note that the charging operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 13B illustrates an unmanned aircraft 2300 including a plurality of rotors 2302. The unmanned aircraft 2300 is sometimes also referred to as a drone. The unmanned aircraft 2300 includes a flexible battery 2301 of one embodiment of the present invention, a camera 2303, and an antenna (not illustrated). The unmanned aircraft 2300 can be remotely controlled through the antenna. The flexible battery 2301 can be bent and thus can be mounted in a curved region of the unmanned aircraft 2300.

FIG. 13C illustrates an example of a robot. A robot 6400 illustrated in FIG. 13C includes a flexible battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like. The flexible battery 6409 can be bent and thus can be mounted in a curved region of the robot 6400.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect the presence of an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the flexible battery 6409 of one embodiment of the present invention and a semiconductor device or an electronic component.

FIG. 13D illustrates an example of a cleaning robot. A cleaning robot 6300 includes a display portion 6302 placed on a top surface of a housing 6301, a plurality of cameras 6303 placed on a side surface of the housing 6301, a brush 6304, operation buttons 6305, a flexible battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on a bottom surface. The flexible battery 6306 can be bent and thus can be mounted in a curved region of the cleaning robot 6300.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes, in its inner region, the flexible battery 6306 of one embodiment of the present invention and a semiconductor device or an electronic component.

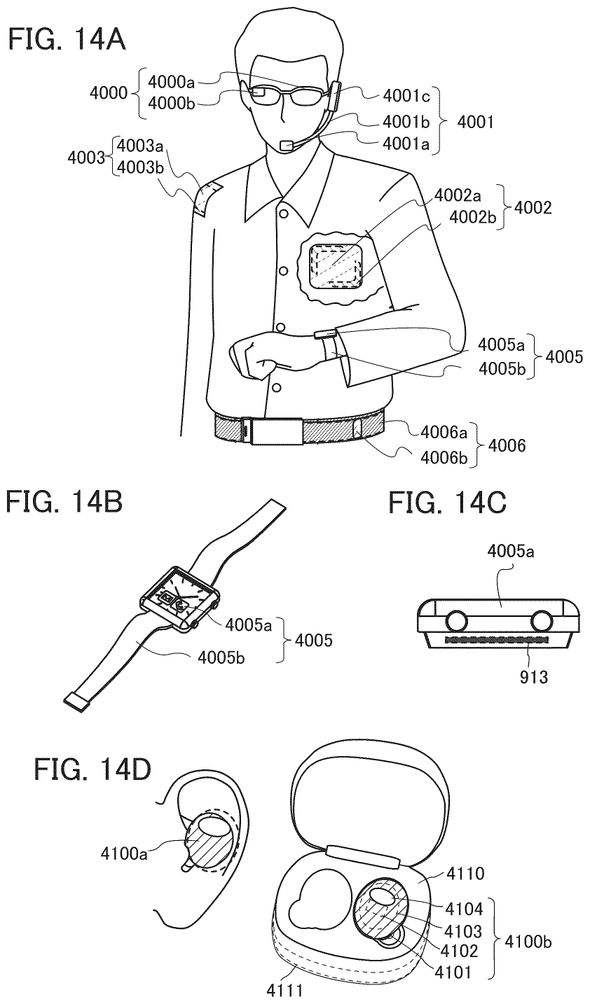

FIG. 14A illustrates examples of wearable devices. A flexible battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the flexible battery of one embodiment of the present invention can be mounted in a glasses-type device 4000 illustrated in FIG. 14A. The glasses-type device 4000 includes a frame 4000a and a display portion 4000b. The flexible battery is mounted in a temple portion of the frame 4000a having a curved shape, whereby the glasses-type device 4000 can be lightweight, can have a well-balanced weight, and can be used continuously for along time. The flexible battery can be bent and mounted in a curved portion.

The flexible battery of one embodiment of the present invention can be mounted in a headset-type device 4001. The headset-type device 4001 includes at least a microphone portion 4001a, a flexible pipe 4001b, and an earphone portion 4001c. The flexible battery can be provided in the flexible pipe 4001b or the earphone portion 4001c. The flexible battery can be bent and mounted in a curved portion.

The flexible battery of one embodiment of the present invention can be mounted in a device 4002 that can be attached directly to a body. A flexible battery 4002b can be provided in a thin housing 4002a of the device 4002. The flexible battery can be bent and mounted in a curved portion.

The flexible battery of one embodiment of the present invention can be mounted in a device 4003 that can be attached to clothes. A flexible battery 4003b can be provided in a thin housing 4003a of the device 4003. The flexible battery can be bent and mounted in a curved portion.

The flexible battery of one embodiment of the present invention can be mounted in a belt-type device 4006. The belt-type device 4006 includes a belt portion 4006a and a wireless power feeding and receiving portion 4006b, and the flexible battery can be mounted in the inner region of the belt portion 4006a. The flexible battery can be bent and mounted in a curved portion.

The flexible battery of one embodiment of the present invention can be mounted in a watch-type device 4005. The watch-type device 4005 includes a display portion 4005a and a belt portion 4005b, and the flexible battery can be provided in the display portion 4005a or the belt portion 4005b. The flexible battery can be bent and mounted in a curved portion.

The display portion 4005a can display various kinds of information such as time and reception information of an e-mail and an incoming call.

The watch-type device 4005 is a wearable device that is wound around an arm directly; thus, a sensor that measures the pulse, the blood pressure, or the like of the user may be mounted therein. Data on the exercise quantity and health of the user can be stored to be used for health maintenance.

FIG. 14B illustrates a perspective view of the watch-type device 4005 that is detached from an arm.

FIG. 14C illustrates a side view. FIG. 14C illustrates a state where a flexible battery 913 is incorporated in the inner region. The flexible battery 913 is provided at a position overlapping with the display portion 4005a, can have high density and high capacity, and is small and lightweight. The flexible battery 913 can be bent and mounted in a curved portion.

FIG. 14D illustrates an example of wireless earphones. The wireless earphones illustrated here include, but are not limited to, a pair of main bodies 4100a and 4100b.

The main bodies 4100a and 4100b each include a driver unit 4101, an antenna 4102, and a flexible battery 4103. A display portion 4104 may also be included. Moreover, a substrate where a circuit such as a wireless IC is provided, a terminal for charge, and the like are preferably included. Furthermore, a microphone may be included. The flexible battery 4103 can be bent and mounted in a curved portion.

A case 4110 includes a flexible battery 4111. Moreover, a substrate where a circuit such as a wireless IC or a charge control IC is provided, and a terminal for charge are preferably included. Furthermore, a display portion, a button, and the like may be included. The flexible battery 4111 can be bent and mounted in a curved portion.

The main bodies 4100a and 4100b can communicate wirelessly with another electronic device such as a smartphone. Thus, sound data and the like transmitted from another electronic device can be played through the main bodies 4100a and 4100b. When the main bodies 4100a and 4100b include a microphone, sound captured by the microphone is transmitted to another electronic device, and sound data obtained by processing with the electronic device can be transmitted to and played through the main bodies 4100a and 4100b. Hence, the wireless earphones can be used as a translator, for example.

The flexible battery 4103 included in the main body 4100a can be charged by the flexible battery 4111 included in the case 4110. The flexible battery 4111 and the flexible battery 4103 can be bent and mounted in a curved portion.

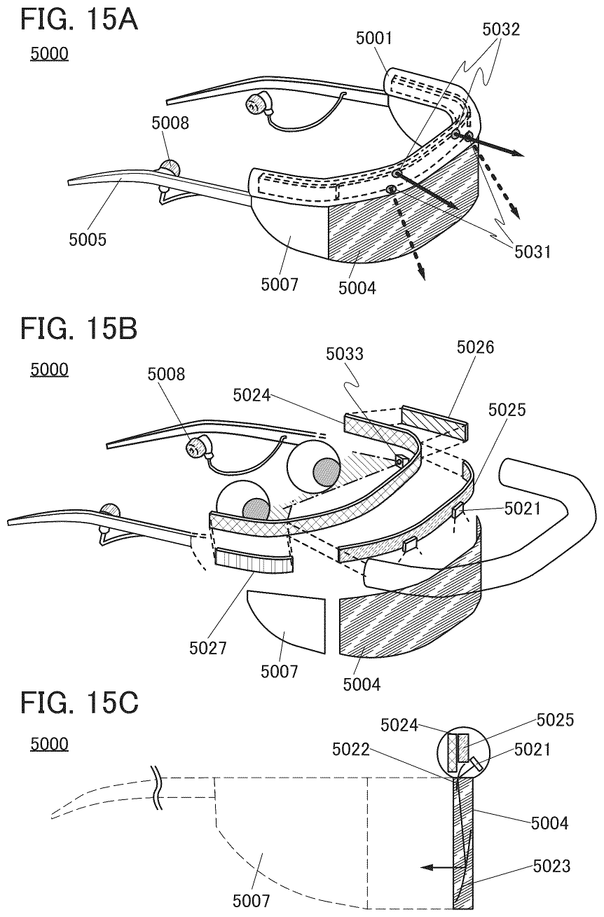

FIG. 15A to FIG. 15C illustrate another example of the glasses-type device. FIG. 15A is a perspective view of a glasses-type device 5000.

The glasses-type device 5000 has a function of what is called a portable information terminal and can execute a variety of programs and reproduce a variety of content when connected to the Internet, for example. For example, the glasses-type device 5000 has a function of displaying augmented reality content in the AR mode. The glasses-type device 5000 may have a function of displaying virtual reality content in the VR mode. Note that the glasses-type device 5000 may also have a function of displaying substitutional reality (SR) content or mixed reality (MR) content, in addition to AR and VR content.

The glasses-type device 5000 includes a housing 5001, an optical member 5004, a wearing tool 5005, a light-blocking unit 5007, and the like. The housing 5001 preferably has a cylindrical shape. The glasses-type device 5000 is preferably wearable on the user's head. Further preferably, the glasses-type device 5000 is worn such that the housing 5001 is positioned above the circumference of the user's head passing through eyebrows and ears. When the housing 5001 has a cylindrical shape that is curved along the user's head, the glasses-type device 5000 can fit more snugly. The housing 5001 is fixed to the optical member 5004. The optical member 5004 is fixed to the wearing tool 5005 with the light-blocking unit 5007 or the housing 5001 therebetween.

The glasses-type device 5000 includes a display device 5021, a reflective plate 5022, a flexible battery 5024, and a system unit. Each of the display device 5021, the reflective plate 5022, the flexible battery 5024, and the system unit is preferably provided inside the housing 5001. The system unit can be provided with a control unit, a memory unit, and a communication unit included in the glasses-type device 5000, a sensor, and the like. The system unit is preferably provided with a charging circuit, a power supply circuit, and the like. The flexible battery 5024 can be bent and mounted in a curved portion.

FIG. 15B illustrates components included in the glasses-type device 5000 in FIG. 15A. FIG. 15B is a schematic view illustrating details of the components included in the glasses-type device 5000 illustrated in FIG. 15A.

In the glasses-type device 5000 illustrated in FIG. 15B, the flexible battery 5024, a system unit 5026, and a system unit 5027 are provided along the cylindrical housing 5001. A system unit 5025 is provided along the flexible battery 5024 and the like.

The housing 5001 preferably has a curved cylindrical shape. When the flexible battery 5024 is provided along the curved cylinder, the flexible battery 5024 can be provided efficiently in the housing 5001 and the space in the housing 5001 can be used efficiently; as a result, the volume of the flexible battery 5024 can be increased in some cases.

The housing 5001 has a cylindrical shape and the axis of the cylinder is along a part of a substantially elliptical shape, for example. A cross section of the cylinder is preferably substantially elliptical, for example. Alternatively, a part of a cross section of the cylinder preferably has a part of an elliptical shape, for example. In particular, in the case where the glasses-type device 5000 is worn on a head, the part of the cross section having a part of an elliptical shape is preferably positioned on a side facing the head. Note that one embodiment of the present invention is not limited thereto. For example, a part of a cross section of the cylinder may have a polygonal (e.g., triangular, quadrangular, or pentagonal) part.

The housing 5001 is formed so as to be curved along the user's forehead, for example. Alternatively, the housing 5001 is positioned along the user's forehead, for example.

The housing 5001 may be formed using two or more cases in combination. For example, the housing 5001 may be formed using an upper case and a lower case in combination. Alternatively, the housing 5001 may be formed using a case on an inner side (a side in contact with the user) and a case on an outer side in combination, for example. The housing 5001 may be formed using three or more cases in combination.

An electrode can be provided in a portion of the housing 5001 in contact with the user's forehead to measure brain waves using the electrode. Alternatively, an electrode may be provided in a portion in contact with the user's forehead to acquire information such as user's sweat using the electrode.

A plurality of flexible batteries 5024 may be provided inside the housing 5001.

The flexible battery 5024 can be provided along the curved cylinder, which is preferable. The flexible battery has flexibility, and thus can be positioned inside the housing more freely. The flexible battery 5024, a system unit, and the like are provided inside the cylindrical housing. The system unit is provided over a plurality of circuit boards, for example. The plurality of circuit boards and the flexible battery are connected using a connecter, a wiring, and the like. The flexible battery has flexibility, and thus can be positioned so as not to overlap with a connector, a wiring, and the like.

Note that the flexible battery 5024 may be provided, for example, inside the wearing tool 5005 as well as inside the housing 5001.

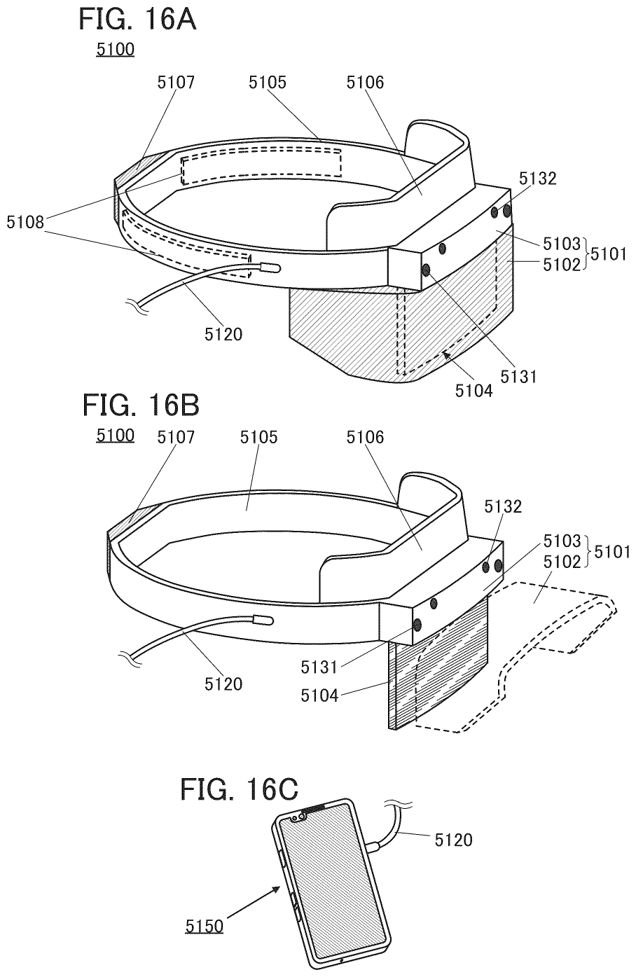

FIG. 16A to FIG. 16C illustrate an example of a head-mounted device. FIG. 16A and FIG. 16B illustrate a head-mounted device 5100 including a wearing tool 5105 with a band-like shape. The head-mounted device 5100 is connected to a terminal 5150 illustrated in FIG. 16C through a cable 5120.

FIG. 16A illustrates a first portion 5102 in a closed state, and FIG. 16B illustrates the first portion 5102 in an opened state. The first portion 5102 has a shape that covers not only the front but also the side of the face in the closed state. Accordingly, the user's view can be blocked from external light, so that realistic sensation and the sense of immersion can be increased. For example, it is also possible to increase user's sense of fear depending on content to be displayed.

In the electronic device illustrated in FIG. 16A and FIG. 16B, the wearing tool 5105 has a band-like shape. Accordingly, the electronic device is less likely to slip as compared with the structure illustrated in FIG. 16A and the like and thus is preferable in enjoying content with relatively large momentum, such as an attraction.

A flexible battery 5107 or the like may be incorporated on the rear head side of the wearing tool 5105. Keeping a balance between the weight of the housing 5101 on the front head side and the weight of the flexible battery 5107 on the rear head side can adjust the center of gravity of the head-mounted device 5100, whereby the device can be worn more comfortably.

A flexible battery 5108 having flexibility may be provided inside the wearing tool 5105 with a band-like shape. FIG. 16A illustrates an example in which two flexible batteries 5108 are provided inside the wearing tool 5105. The flexible battery having flexibility is preferably used, in which case the flexible battery can have a curved band shape.

The wearing tool 5105 includes a portion 5106 covering the user's forehead or front head.

Owing to the portion 5106, the wearing tool 5105 is less likely to slip. An electrode can be provided in the portion 5106 or a portion of the housing 5101 in contact with the user's forehead to measure brain waves using the electrode.

This embodiment can be implemented in appropriate combination with the other embodiments.

### REFERENCE NUMERALS

10: secondary battery, 20: positive electrode, 21: positive electrode lead, 22: positive electrode current collector, 23: positive electrode active material layer, 30: negative electrode, 31: negative electrode lead, 32: negative electrode current collector, 33: negative electrode active material layer, 34: negative electrode active material, 35: binder, 40: separator, 50: exterior body, 51: sealing portion, 52: sealing portion

1. A secondary battery comprising a positive electrode and a negative electrode,
wherein the positive electrode comprises a positive electrode current collector,
wherein the negative electrode comprises a negative electrode current collector, and
wherein one of the positive electrode current collector and the negative electrode current collector comprises a first rubber material.

2. A secondary battery comprising a positive electrode and a negative electrode,
wherein the positive electrode comprises a positive electrode current collector,
wherein the negative electrode comprises a negative electrode current collector, and
wherein one of the positive electrode current collector and the negative electrode current collector has rubber elasticity.

3. A secondary battery comprising a positive electrode and a negative electrode,
wherein the positive electrode comprises a positive electrode current collector,
wherein the negative electrode comprises a negative electrode current collector,
wherein the positive electrode current collector comprises a first rubber material, and
wherein the negative electrode current collector comprises a second rubber material.

4. A secondary battery comprising a positive electrode and a negative electrode,
wherein the positive electrode comprises a positive electrode current collector,
wherein the negative electrode comprises a negative electrode current collector, and
wherein each of the positive electrode current collector and the negative electrode current collector has rubber elasticity.

5. The secondary battery according to claim 1,
wherein the secondary battery has flexibility and has at least a first shape and a second shape, and
wherein a thickness of the positive electrode current collector in the first shape is smaller than a thickness of the positive electrode current collector in the second shape.

6. The secondary battery according to claim 1,
wherein the secondary battery has flexibility and has at least a first shape and a second shape, and
wherein a thickness of the negative electrode current collector in the first shape is smaller than a thickness of the negative electrode current collector in the second shape.

7. The secondary battery according to claim 1,
wherein the positive electrode comprises a positive electrode active material layer on at least one surface of the positive electrode current collector, and
wherein the positive electrode active material layer comprises a positive electrode active material and a second rubber material.

8. The secondary battery according to claim 3,
wherein the positive electrode comprises a positive electrode active material layer on at least one surface of the positive electrode current collector, and
wherein the positive electrode active material layer comprises a positive electrode active material and a third rubber material.

9. The secondary battery according to claim 3,
wherein the negative electrode comprises a negative electrode active material layer on at least one surface of the negative electrode current collector, and
wherein the negative electrode active material layer comprises a negative electrode active material and a third rubber material.

10. The secondary battery according to claim 2,
wherein the positive electrode comprises a positive electrode active material layer on at least one surface of the positive electrode current collector, and
wherein the positive electrode active material layer comprises a positive electrode active material and a rubber material.

11. The secondary battery according to claim 2,
wherein the negative electrode comprises a negative electrode active material layer on at least one surface of the negative electrode current collector, and
wherein the negative electrode active material layer comprises a negative electrode active material and a rubber material.

12. The secondary battery according to claim 9,
wherein the second rubber material and the third rubber material are each styrene-butadiene rubber.

13. The secondary battery according to claim 1,
wherein the secondary battery comprises an exterior body surrounding the positive electrode and the negative electrode, and
wherein the exterior body comprises a projection and a depression.

14. An electronic device comprising the secondary battery according to claim 1.

15. The secondary battery according to claim 2,
wherein the secondary battery has flexibility and has at least a first shape and a second shape, and
wherein a thickness of the positive electrode current collector in the first shape is smaller than a thickness of the positive electrode current collector in the second shape.

16. The secondary battery according to claim 2,
wherein the secondary battery has flexibility and has at least a first shape and a second shape, and
wherein a thickness of the negative electrode current collector in the first shape is smaller than a thickness of the negative electrode current collector in the second shape.

17. The secondary battery according to claim 3,
wherein the secondary battery has flexibility and has at least a first shape and a second shape, and
wherein a thickness of the positive electrode current collector in the first shape is smaller than a thickness of the positive electrode current collector in the second shape.

18. The secondary battery according to claim 3,
wherein the secondary battery has flexibility and has at least a first shape and a second shape, and
wherein a thickness of the negative electrode current collector in the first shape is smaller than a thickness of the negative electrode current collector in the second shape.

19. The secondary battery according to claim 4,
wherein the secondary battery has flexibility and has at least a first shape and a second shape, and
wherein a thickness of the positive electrode current collector in the first shape is smaller than a thickness of the positive electrode current collector in the second shape.

20. The secondary battery according to claim 4,
wherein the secondary battery has flexibility and has at least a first shape and a second shape, and
wherein a thickness of the negative electrode current collector in the first shape is smaller than a thickness of the negative electrode current collector in the second shape.

21. The secondary battery according to claim 4,
wherein the positive electrode comprises a positive electrode active material layer on at least one surface of the positive electrode current collector, and
wherein the positive electrode active material layer comprises a positive electrode active material and a rubber material.

22. The secondary battery according to claim 4,
wherein the negative electrode comprises a negative electrode active material layer on at least one surface of the negative electrode current collector, and
wherein the negative electrode active material layer comprises a negative electrode active material and a rubber material.
